(19) United States
(12) Patent Application Publication
(10) Pub. No.: US 2014/0193155 A1
(43) Pub. Date: Jul. 10, 2014

(54) Microphotonic Coupled-Resonator Devices

(71) Applicants: Milos Popovic, Boulder, CO (US); Mark Taylor Wade, Boulder, CO (US); Xiaoge Zeng, Boulder, CO (US)

(72) Inventors: Milos Popovic, Boulder, CO (US); Mark Taylor Wade, Boulder, CO (US); Xiaoge Zeng, Boulder, CO (US)

(73) Assignee: The Regents of the University of Colorado, a body corporate, Denver, CO (US)

(21) Appl. No.: 14/152,775

(22) Filed: Jan. 10, 2014

Related U.S. Application Data
(60) Provisional application No. 61/751,145, filed on Jan. 10, 2013.
(60) Provisional application No. 61/751,170, filed on Jan. 10, 2013.

(51) Int. Cl. H04J 14/02; G02F 1/365

(52) U.S. Cl. CPC H04J 14/02; G02F 1/365
USPC 398/82; 385/122; 385/31; 29/428

(57) ABSTRACT

An optical resonator supports three resonance modes and having third-order optical nonlinearity. One or more waveguides are coupled to the three resonant modes. A waveguide input port is more strongly coupled to the first resonant mode than to the second and third resonant modes. A waveguide output port is more strongly coupled to at least one of the second and third resonant modes than to the first resonant mode. An optical filter has at least two optical resonators. The optical filter provides a passband having at least two poles and a transmission zero positioned outside the two poles. An optical demultiplexer includes first optical filter coupled in series with a second optical filter. Both optical filters provide a passband having at least two poles and a zero positioned outside the two poles. The zero of the first filter is located within the passband of the second filter.

This application claims benefit of priority to U.S. Provisional Application No. 61/751,145, entitled “Micro-optical Parametric Oscillators, Amplifiers, and Wavelength Converters” and filed on Jan. 10, 2013, and to U.S. Provisional Application No. 61/751,170 entitled “Pole-Zero Resonant Demultiplexers” and filed on Jan. 10, 2013, both of which are specifically incorporated by reference herein for all that they disclose and teach.

### BACKGROUND

The integration of photonics with microelectronics offers significant improvements to chip-to-chip communications systems and optical signal processing systems, particularly with regard to energy efficiency and bandwidth. For example, on-chip coherent light generators can be used as light sources and amplifiers. Also, on-chip microphotonic filter banks and demultiplexers can be used in photonic interconnects. Specific design of such components, however, presents unique challenges.

### SUMMARY

Implementations described and claimed herein address the foregoing by providing a resonant photonic device including an optical resonator supporting a first resonance mode having a first resonant frequency, a second resonant mode having a second resonant frequency, and a third resonant mode having a third resonant frequency. The optical resonator has third-order optical nonlinearity. One or more waveguides are coupled to each of the three resonant modes. The one or more waveguides include an optical input port and an optical output port. The optical input port is more strongly coupled to the first resonant mode than to the second and third resonant modes. The optical output port is more strongly coupled to at least one of the second and third resonant modes than to the first resonant mode.

In another implementation, an optical filter is provided with at least two optical resonators. An input waveguide is optically coupled to a first optical resonator and a second optical resonators. An output waveguide is directly optically coupled to the first optical resonator, wherein the optical filter is configured to provide a passband having at least two poles and a transmission zero positioned outside a frequency range between the two poles.

In another implementation, an optical demultiplexer is provided. A first optical filter is configured to provide a first passband having at least two first poles and a first zero positioned outside a first frequency range associated with the two poles. The first zero is shifted from a center of the first passband by a channel spacing. A second optical filter is coupled in series with the first optical filter. The second optical filter is configured to provide a second passband having at least two second poles and a second zero positioned outside a second frequency range associated with the two second poles. The first zero is located within the second passband.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIGS. 1a, 1b, and 1c illustrate example micro-OPO models including a multimode resonator, a traveling-wave resonant structure, and a multimode resonator structure based on 3 coupled microring cavities.

FIGS. 2a, 2b and 2c illustrate example plots of maximum efficiency and corresponding optimum external coupling rates for the pump and signal/idler as a function of the nonlinear loss sine and normalized input pump power.

FIGS. 3a and 3b illustrate performance comparisons of OPO designs with optimum unequal pump and signal/idler couplings and with optimized equal couplings (assuming no FCA).

FIGS. 4a, 4b, and 4c illustrate example normalized design curves for optimum OPO design when all TPA terms are included (without FCA).

FIGS. 5a, 5b, and 5c illustrate a comparison between two cases, one with partial (pump-assisted only) TPA and the other with full TPA.

FIGS. 6a and 6b illustrate example OPO design curves for nonlinear media with and without TPA loss (assuming no FCA).

FIG. 7 illustrates performance of an example silicon microcavity at 1500 nm resonance with various free-carrier lifetimes and intrinsic cavity quality factors.

FIGS. 8a and 8b illustrate an OPO threshold versus (a) normalized free carrier lifetimes and σ₃; and (b) free carrier lifetime for a silicon cavity resonant near 1550 nm with linear unloaded Q of 10⁶ and effective volume of 8.4 μm³.

FIGS. 9a, 9b, 9c, and 9d illustrate examples of various microphotonic coupled-resonator structure topologies.

FIG. 10 illustrates an example model of small signal gain and loss in an optical parametric oscillator based on degenerate four wave mixing (FWM).

FIG. 11 illustrates example operations for making and using an optical parametric oscillator based on degenerate four wave mixing (FWM).

FIGS. 12a and 12b illustrate an example 2^{nd}-order resonance system capable of a 2-pole, 1-zero response.

FIGS. 13a, 13b, and 13c illustrate a variety of example higher-order filters, each with a drop-port transmission zero.

FIG. 14 illustrates an example response of a 2^{nd}-order filter and a zero placed at δω_{zd}=10rᵢ.

FIG. 15 illustrates an abstract photonic circuit used to derive the T-matrix of a tapped filter.

FIG. 16 illustrates an example graphical representation of a drop-port zero location in the complex-δω plane.

FIG. 17 illustrates a comparison of an example pole-zero filter with an asymmetric response and an all pole Butterworth filter response.

FIGS. 18a, 18b, 18c, and 18d illustrate an example serial demultiplexer with symmetrized, densely packed passbands by using asymmetric response filters and associated responses.

FIG. 19 illustrates responses of an example demultiplexer design using pole-zero filters showing 20 GHz passbands with 44 GHz channel spacing.

FIGS. 20a, 20b, 20c, and 20d illustrate example device topologies that support a 2-pole, 1-zero response.

FIG. 21 illustrates example operations for making and using an optical pole-zero filter.

FIG. 22 illustrates another example resonant photonic device topology.

### DETAILED DESCRIPTIONS

High field strengths in optical microresonators can introduce nonlinear optical effects that present opportunities for innovation in the design of integrated optical networks and microphotonic devices. Silicon-based microphotonic coupled-resonators can, for example, contribute to the development of on-chip ultra-high bandwidth optical communication networks. Encoding information on-chip using multiple wavelength channels using wavelength division multiplexing (WDM), for example, can provide communication bandwidths in excess of one terabit/second. In one implementation, effective on-chip coherent light generation and amplification for such systems may be achieved using microcavity-based optical parametric oscillators (OPOs) based on third-order nonlinearity. In another implementation, on-chip microphotonic filter banks for use in WDM may be designed using microphotonic coupled-resonator filters with asymmetric spectral responses (e.g., pole-zero filters) to provide performance improvements over all-transmission-pole filters.

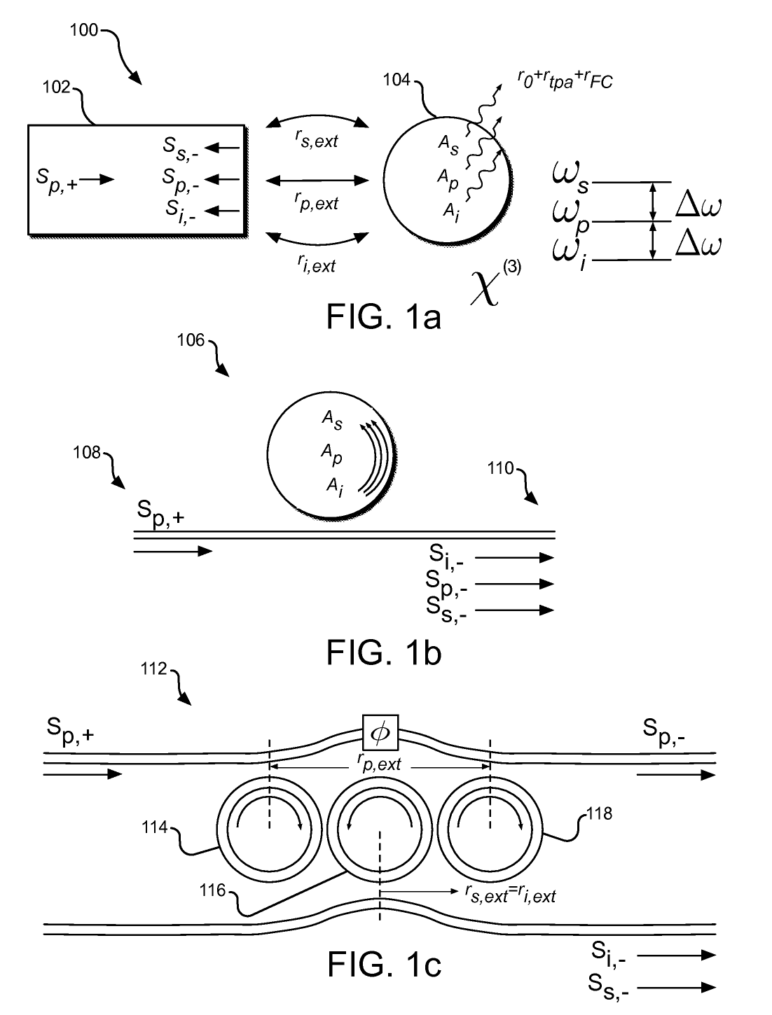

With regard to microcavity-based optical parametric oscillators (OPOs) based on third-order nonlinearity, the nonlinearity is greatly enhanced in a microcavity by strong transverse spatial confinement and large effective interaction length. FIG. 1a illustrates an example micro-OPO model 100 including input/output ports 102 and a multimode resonator 104. In one implementation, the OPO is constructed based on degenerate four-wave mixing (FWM) to achieve a high conversion efficiency. The model 100 depicts a coupled mode theory in time (CMT) model, which is valid to describe the dynamics of linear and nonlinear phenomena in microcavities in the weak nonlinearity regime, χ⁽³⁾|E|²<<1. The model 100 illustrates three resonantly-enhanced, interacting frequencies (one signal frequency s, one degenerate pump frequency p, and one idler frequency i). The resonant system of the model 100 comprises three resonant modes, one each to resonantly enhance the pump (degenerate), signal, and idler wavelengths. FIG. 1b shows a traveling-wave resonant structure 106 that enables separates input and output ports 108 and 110. FIG. 1c shows a multimode resonator 112 based on 3 coupled microring cavities 114, 116, and 118, with unequal pump and signal/idler eternal coupling. In one implementation, the input port 108 is more strongly coupled to the pump resonant mode than to either of the signal or idler resonant modes, and the output port 110 is more strongly coupled to one or both of the signal or idler resonant modes than to the pump resonant mode. In one implementation, each microring cavity is a photonic crystal resonant cavity.

The CMT model for the three resonance systems illustrated in FIGS. 1a, 1b, and 1c is given as:

$$\begin{matrix}\frac{d {A}_{s}}{d t} = - {r}_{s , tot} {A}_{s} - {jω}_{s} {β}_{fwm , s} {A}_{p}^{2} {A}_{i}^{*} & ( 1 a ) \\ \frac{d {A}_{p}}{d t} = - {r}_{p , tot} {A}_{p} - {j2ω}_{p} {β}_{fwm , p} {A}_{p}^{*} {A}_{s} {A}_{i} - j \sqrt{2 {r}_{p , ext}} {S}_{p , +} & ( 1 b ) \\ \frac{d {A}_{i}}{d t} = - {r}_{i , tot} {A}_{i} {jω}_{i} {β}_{fwm , i} {A}_{p}^{2} {A}_{s}^{*} & ( 1 c ) \\ {S}_{s , -} = - j \sqrt{2 {r}_{s , ext}} {A}_{s} & ( 1 d ) \\ {S}_{p , -} = {S}_{p , +} - j \sqrt{2 {r}_{p , ext}} {A}_{p} & ( 1 e ) \\ {S}_{i , -} = - j \sqrt{2 {r}_{i , ext}} {A}_{i} & ( 1 f )\end{matrix}$$

where Aₖ (t), kε{p, s,i}, are the cavity energy-amplitude envelopes for light at the pump frequency, the signal frequency, and the idler frequency, respectively (|Aₖ|² is mode k energy); S_{k,+}(S_{k,-}) is the power envelope in the input (output) port for each resonant mode (|Sₖ|² is the mode k power); ωₖ are the angular frequencies of the interacting modes; and β_{fwm,k} are the FWM (parametric gain) coefficients, related to modal field overlap integrals in Appendix A. The term “envelope” refers to Aₖ(t), which is related to the usual CMT amplitude aₖ(t) by aₖ(t)≡Aₖ(t)e^{jω}^{ₖ}¹.

The mode field patterns are normalized to unity energy or power, such that |Aₖ|² is the energy of the resonant mode k and |S_{k,+}|²(|S_{k,-}|) is the inbound (outbound) power in guided mode k, which correspond to each term in the denominators of overlap integrals (A1) and (A3) in Appendix A being set to unity. The coefficients β_{fwm,s}, β*_{fwm,p}, and β_{fwm,i} are identical except for the tensor element of χ⁽³⁾ that they contain. Under the assumption of full permutation symmetry, these tensor elements and hence the foregoing coefficients are equal. Accordingly, a single β_{fwm} is defined:

β_{fwm,s}=β_{fwm,p}=β_{fwm,i}=β_{fwm} (2)

Decay rate r_{k,tot} is the mode-k total energy amplitude decay rate (due to both loss and coupling to external ports), and r_{k,est} is the corresponding coupling to external ports, where

r_{s,tot}=r_{s,o}+r_{s,ext}+r_{FC}+ωₛ(β_{tpa,ss}|Aₛ|²+2β_{tpa,sp}|Aₚ|²+2β_{tpa,si}|Aᵢ|²)

r_{p,tot}=r_{p,o}+r_{p,ext}+r_{FC}+ωₚ(2β_{tpa,sp}|Aₛ|²+β_{tpa,pp}|Aₚ|²+2β_{tpa,ip}|Aᵢ|²)

r_{i,tot}=r_{i,o}+r_{i,ext}+r_{FC}+ωᵢ(2β_{tpa,si}|Aₛ|²+β_{tpa,ip}|Aₚ|²+β_{tpa,ii}|Aᵢ|²). (3)

In Equation (2), r_{k,o},kε{s,p,i} represents the linear loss rate of mode k, and β_{tpa,mn} is the two-photon absorption coefficient due to absorption of a photon each from modes m and n (m, nε{s,p,i}). β_{tpa,mn} should not be confused with the coefficient β_{TPA} typically used in the nonlinear optics literature, which is a bulk (plane wave) value, is defined through dI/dz=β_{TPA}|², and represents “nonlinear loss” per unit length. β_{tpa,mn} here has units of “nonlinear loss” per unit time (for a resonant mode) and includes a spatial mode overlap integral to account for the spatial inhomogeneity of the field and combines it into a single effective factor (defined in Appendix A).

The decay rate includes a contribution due to free-carrier absorptions (FCA). The FCA loss rate, r_{FC}, is not a constant like the other rates and coefficients r_{k,o}, r_{k,ext}, and β_{tpa,mn} in Equation (3) but instead depends on intensities. The FCA loss rate, r_{FC}, is relevant in cavities with nonlinear loss, such as silicon-core resonators, and is given by Equation (4) (immediately below—see also Appendix B):

$${r}_{FC} = \frac{{τ}_{FC} {σ}_{a} {υ}_{g}}{2 \overline{h} {V}_{eff}} ( {β}_{tpa , ss} {\vert {A}_{s} \vert}^{4} + {β}_{tpa , pp} {\vert {A}_{p} \vert}^{4} + {β}_{tpa , ii} {\vert {A}_{i} \vert}^{4} + 4 {β}_{tpa , sp} {\vert {A}_{s} \vert}^{2} {\vert {A}_{p} \vert}^{2} + 4 {β}_{tpa , ip} {\vert {A}_{i} \vert}^{4} {\vert {A}_{p} \vert}^{2} + 4 {β}_{tpa , si} {\vert {A}_{s} \vert}^{4} {\vert {A}_{i} \vert}^{2} )$$

where τ_{FC} is the free carrier lifetime, σₐ is the free carrier absorption cross section area per electron-hole pair, and ν_{g} is group velocity. V_{eff} is an effective volume of the resonant mode, as defined in Appendix A.

Without loss of generality, a few approximations and assumptions are made, as follows. Note that, rigorously, there is only one S₋ (output) port and one S₊ (input) port in the system shown in FIGS. 1a, 1b, and 1c, and the above S_{k,=} are respective parts of the spectrum of S_{±}. An approximation relevant to OPO analysis is that the wavelength spacing of the pump resonance, the signal resonance, and the idler resonance is larger than their linewidth and that at least nearly continuous-wave (CW) operations exists, so that e.g., the signal input wave S_{s,+} affects only the signal resonance and does not excite the other two resonances directly, etc. With this approximation, the three spectral components can be treated as separate ports.

It is also assumed that the wavelengths of pump input, S_{p.+} the signal output, S_{s,-} and the idler output, S_{i,-}, match the cavity resonances, and that the cavity resonances themselves are spaced to satisfy photon energy conversion in the nonlinear process, 2ωₚ=ωₛ=ωᵢ. It is also assumed that self-phase and cross-phase modulation and free-carrier induced index change, which result in shifts of the resonance frequencies during operation from their cold cavity (no excitation) values, can be ignored.

In one implementation, unseeded operation of an OPO (free oscillation) is considered in the model of FIGS. 1a, 1b, and 1c. There is no input power at the signal frequency and the idler frequency beyond noise that is involved to start the FWM process. Also, six unique β_{tpa,mn} coefficients provided in Equation (3). Accordingly, rather than defining a single nonlinear figure of merit (NFOM) for performance in integrated photonic structures, a d-vector is introduced to describe the topological mode structure aspects that give rise to the differences in the six TPA coefficients β_{tpa,mn}.

Furthermore, in order to arrive at a single TPA coefficient, β_{tpa,mn}=βₜₚₐ, in certain aspects of the analysis, a single, traveling wave cavity configuration is assumed, with traveling wave excitation. In addition, the TPA coefficient, βₜₚₐ is defined in Equation (A3) in Appendix A and contains the same field overlap integral as β_{fwm}, defined in Equation (A1). This correspondence allows relation of the OPO design to the conventional NFOM. However, instead of using the conventional NFOM, a nonlinear loss parameter, σ₃, is defined, based on the inverse of the conventional NFOM, as a property of the nonlinear material alone. The nonlinear loss parameter, σ₃, is referred to as the nonlinear loss sine and is defined as

$${σ}_{3} ≡ \frac{ \vert {χ}^{( 3 )} \vert}{\vert {χ}^{( 3 )} \vert} = \frac{{β}_{tpa}}{{β}_{fwm}} \qquad ( 5 )$$

where χ⁽³⁾ is assumed to be scalar. βₜₚₐ is referenced to a traveling-wave single-ring design—uniform field along the cavity length and ωₚ≈ωₛ≈ωᵢ. In the general case, βₜₚₐ is replaced by several coefficients, β_{tpa,pp}, etc., but σ₃ can still be defined by the left expression in Equation (5) via χ⁽³⁾. The nonlinear loss sine σ₃ depends only on material parameters and not on the overlap integral in the case where a single material in the device dominates nonlinear behavior, because the FWM and TPA have the same overlap dependence. In the case where multiple nonlinear materials are present in the cavity, the definition of σ₃ is generalized to include overlap integrals in order to represent the ratio of two photon absorption to parametric gain. Since σ₃ characterizes the relative magnitude of TPA and FWM effects, it is related to the NFOM typically used in the context of nonlinear optical switching,

$$NFOM = \frac{\sqrt{1 - {σ}_{3}^{2}}}{( 4 {πσ}_{3} )} .$$

For silicon near 1550 nm, σ₃≈0.23.

It is also assumed that each resonance has the same linear loss, r_{k,o}=rₒ. In addition, due to the symmetry of the model 100 in the regime of Δω/ωₚ<<1, where Δω=ωₚ−ωₛ=ωₚ (sufficiently that the signal, idler, and pump mode fields confinement is similar), it is assumed that ωₛ≈ωᵢ≈ω and equal external coupling for the signal and idler resonances, r_{s,ext}=r_{i,ext}.

The CMT model may be written in normalized form:

$$\begin{matrix}\frac{d {B}_{s}}{d t} = - {ρ}_{s , tot} {B}_{s} - j 2 {B}_{p}^{2} {B}_{i}^{*} & ( 6 a ) \\ \frac{d {B}_{p}}{d t} = - {ρ}_{p , tot} {B}_{p} - j 4 {B}_{p}^{*} {B}_{s} {B}_{i} - j \sqrt{2 {ρ}_{p , ext}} {T}_{p , +} & ( 6 b ) \\ \frac{d {B}_{i}}{d t} = - {ρ}_{i , tot} {B}_{i} - j 2 {B}_{p}^{2} {B}_{s}^{*} & ( 6 c ) \\ {T}_{s , -} = - j \sqrt{2 {ρ}_{s , ext}} {B}_{s} & ( 6 d ) \\ {T}_{p , -} = {T}_{p , +} - j \sqrt{2 {ρ}_{p , ext}} {B}_{p} & ( 6 e ) \\ {T}_{i , -} = - j \sqrt{2 {ρ}_{i , ext}} {B}_{i} & ( 6 f )\end{matrix}$$

The normalize variables are defined by:

$$\begin{matrix} τ ≡ {r}_{0} t & ( 7 a ) \\ {B}_{k} = \frac{{A}_{k}}{{A}_{o}} , \\ with {A}_{0} ≡ \sqrt{\frac{2 {r}_{0}}{{ωβ}_{fwm}}} & ( 7 b ) \\ {T}_{k , \pm } = \frac{{S}_{k , \pm }}{{S}_{o}} , \\ with \\ {S}_{0} ≡ \sqrt{\frac{2 {r}_{o}^{2}}{{ωβ}_{fwm}}} & ( 7 c ) \\ {ρ}_{s , tot} ≡ 1 + {ρ}_{s , ext} + 2 {σ}_{3} ( {d}_{ss} {\vert {B}_{s} \vert}^{2} + 2 {d}_{sp} {\vert {B}_{p} \vert}^{2} + 2 {d}_{si} {\vert {B}_{i} \vert}^{2} ) + {ρ}_{FC} & ( 7 d ) \\ {ρ}_{p , tot} ≡ 1 + {ρ}_{p , ext} + 2 {σ}_{3} ( 2 {d}_{sp} {\vert {B}_{s} \vert}^{2} + {d}_{pp} {\vert {B}_{p} \vert}^{2} + 2 {d}_{ip} {\vert {B}_{i} \vert}^{2} ) + {ρ}_{FC} & ( 7 e ) \\ {ρ}_{i , tot} ≡ 1 + {ρ}_{i , ext} + 2 {σ}_{3} ( 2 {d}_{si} {\vert {B}_{s} \vert}^{2} + 2 {d}_{ip} {\vert {B}_{p} \vert}^{2} + {d}_{ii} {\vert {B}_{i} \vert}^{2} ) + {ρ}_{FC} & ( 7 f )\end{matrix}$$

Normalized energy amplitudes Bₖ and wave amplitudes T_{k,+}, T_{k,-} are determined by normalizing out the linear loss rate rₒ, parametric coupling β_{fwm} and nonlinear loss βₜₚₐ from the problem. Note in Equation (7c) that the input/output wave power, |S_{k,π}|² is normalized to |Sₒ|², which is the linear-loss oscillation threshold (the oscillation threshold in the absence of nonlinear losses).

The terms

$${ρ}_{k , tot} ≡ \frac{{r}_{k , tot}}{{r}_{o}}$$

$$and$$

$${ρ}_{k , ext} ≡ \frac{{r}_{k , ext}}{{r}_{o}} , \\ k ∈ \{ s , p , i \}$$

represent normalized decay rates. The nonlinear loss sine σ₃ has been introduced to provide an economical formalism to account fully for nonlinear loss. In order to preserve the generality of the six independent terms, β_{tpa,mn} coefficients are defined as:

$${d}_{mn} ≡ \frac{{β}_{tpa , mn}}{{σ}_{3} {β}_{fwm}} , \qquad ( 8 )$$

which serve as prefactors to the overlap integral (βₜₚₐ=σ₃β_{fwm}) of the reference case—a single-cavity with traveling-wave mode. These six coefficients are a property of the particular resonator topology, and excitation (standing vs. traveling wave), and they together with the nonlinear loss sine σ₃ characterizes a device's nonlinear performance merits related to TPA.

With the model reduced to a minimum number of coefficients, the normalized free-carrier absorption rate is given by Equation (9) below:

$${ρ}_{FC} ≡ \frac{{r}_{FC}}{{r}_{o}} = {σ}_{3} {ρ}_{FC}^{′} ( \begin{matrix}{d}_{ss} {\vert {B}_{s} \vert}^{4} + {d}_{pp} {\vert Bp \vert}^{4} + {d}_{ii} {\vert {B}_{i} \vert}^{4} + 4 {d}_{sp} {\vert {B}_{s} \vert}^{2} {\vert {B}_{p} \vert}^{2} + \\ 4 {d}_{ip} {\vert {B}_{i} \vert}^{2} {\vert {B}_{p} \vert}^{2} + 4 {d}_{si} {\vert {B}_{s} \vert}^{2} {\vert {B}_{i} \vert}^{2}\end{matrix} )$$

where a normalized FCA coefficient is defined as:

$${ρ}_{FC}^{′} ≡ \frac{{τ}_{FC} {σ}_{a} {υ}_{g}}{{V}_{eff}} \frac{{β}_{fwm}}{2 ℏ} \frac{4 {r}_{o}}{{( ω {β}_{fwm} )}^{2}} = ( \frac{{σ}_{a} {n}_{n !}^{2}}{ℏω {n}_{g} {n}_{2}} ) \frac{{τ}_{FC}}{{Q}_{o}} .$$

The normalized FCA rate, ρ_{c}, depends on nonlinear lose sine σ₃, the topological d coefficients, the normalized mode energies (|Bₖ|²), and a remaining set of parameters combined into ρ′_{FC}. Accordingly, the FCA effect can be characterized by only one parameter, ρ′_{FC}, dependent on material nonlinearity, cavity properties and the ratio of free carrier lifetime, τ_{FC}, and linear loss Q, Qₒ. From this, it can be seen that free carrier loss depends only on the ration of free carrier lifetime to the cavity photon lifetime, τₒ, where

$${Q}_{o} ≡ \frac{{ω}_{o} {τ}_{o}}{2} .$$

The larger τ_{FC}/Qₒ, i.e., τ_{FC}/τₒ, the higher the FCA losses.

An optimum OPO design given certain material parameters is defined as one that, for a given input pump power, provides the maximum output signal (idler) power that can be generated through FWM (e.g., has maximum conversion efficiency). The power conversion efficiency η is defined as

$$η ≡ \frac{{\vert {S}_{s , -} \vert}^{2}}{{\vert {S}_{p , +} \vert}^{2}} \qquad ( 10 )$$

For similar photon energies, the maximum efficiency is 50% to each of the signal and idler wavelengths, as two pump photons are converted to one signal photon and one idler photon.

Designing an OPO is a multistage process. A first stage involves the design of resonances for the pump, signal, and idler wavelengths that have substantial field overlap and satisfy the energy (frequency) and momentum (propagation constant) conversation conditions (the latter automatically holds for resonances with appropriate choices of resonant orders). In one implementation, unequal waveguide coupling to the pump and signal/idler resonances presents advantageous design results.

For continuous-wave operation, the steady state conditions of the system. Steady state is characterized by

$$\frac{d {B}_{k}}{d t} = 0 ,$$

which leads to the following:

$$\begin{matrix}{B}_{s} = - 2 j {ρ}_{s , tot}^{- 1} {B}_{p}^{2} {B}_{i}^{*} & ( 11 ) \\ {B}_{i} = - 2 j {ρ}_{i , tot}^{- 1} {B}_{p}^{2} {B}_{s}^{*} & ( 12 ) \\ {T}_{p , +} = j \frac{{ρ}_{p , tot} {B}_{p} + 4 j {B}_{p}^{*} {B}_{s} {B}_{i}}{\sqrt{2 {ρ}_{p , ext}}} & ( 13 )\end{matrix}$$

In one implementation, the OPO design is based on a traveling-wave, single-cavity model with pump-assisted TPA only and no FCA. In practice, this model is directed to three resonant modes with nearly identical time-average spatial intensity patterns. This model results in a topological d-vector

dₛₛ=dₚₚ=dᵢᵢ=dₛₚ=dₛᵢ=dᵢₚ=1. (14)

In this model, the nonlinear loss is dominated by pump-assisted TPA for all three frequencies and other weaker TPA contributions are ignored (e.g., the dₛₛ, dᵢᵢ, and dₛᵢ terms are dropped from Equations (7d) and (7f) and the dₛₚ and dᵢₚ terms are dropped from Equation (7e)). Ignoring the weaker TPA contributions is valid in the weak conversion regime, relevant to many practical situations, where the generated signal and idler light is much weaker than the pump light in the cavity. For this model, loss due to free carrier absorption is also ignored because it may be effectively reduced by carrier sweep-out using, for example, a reverse biased p-i-n diode.

Based on these criteria, the loss rates in Equations (7d-7f) have the simpler form

ρ_{s,tot}=1+ρ_{s,ext}+4σ₃|Bₚ|²

ρ_{p,tot}=1+ρ_{p,ext}+2σ₃|Bₚ|²

ρ_{is,tot}=1+ρ_{i,ext}+4σ₃|Bₚ|²

where signal and idler external coupling are equal, as already discussed. The steady state operating point from Equations (11) and (12) give either

$$\begin{matrix}{\vert {B}_{s} \vert}^{2} = {\vert {B}_{i} \vert}^{2} = 0 & ( below threshold )\end{matrix} \\ or \\ \begin{matrix}{\vert {B}_{p} \vert}^{2} = \frac{( 1 + {ρ}_{s , ext} )}{2 ( 1 - 2 {σ}_{3} )} & ( above threshold ) .\end{matrix} \qquad ( 16 )$$

Note that in the present model that considers pump-assisted TPA only, the stead-state pump resonator-mode energy |Bₚ|² is independent of both the input pump power |T_{p,+}|² and the pump external coupling ρ_{p,ext}. Nevertheless, the choice of external coupling (both pump and signal/idler) depends on the input pump power, |T_{p,+}|² (or |S_{p.+}|²).

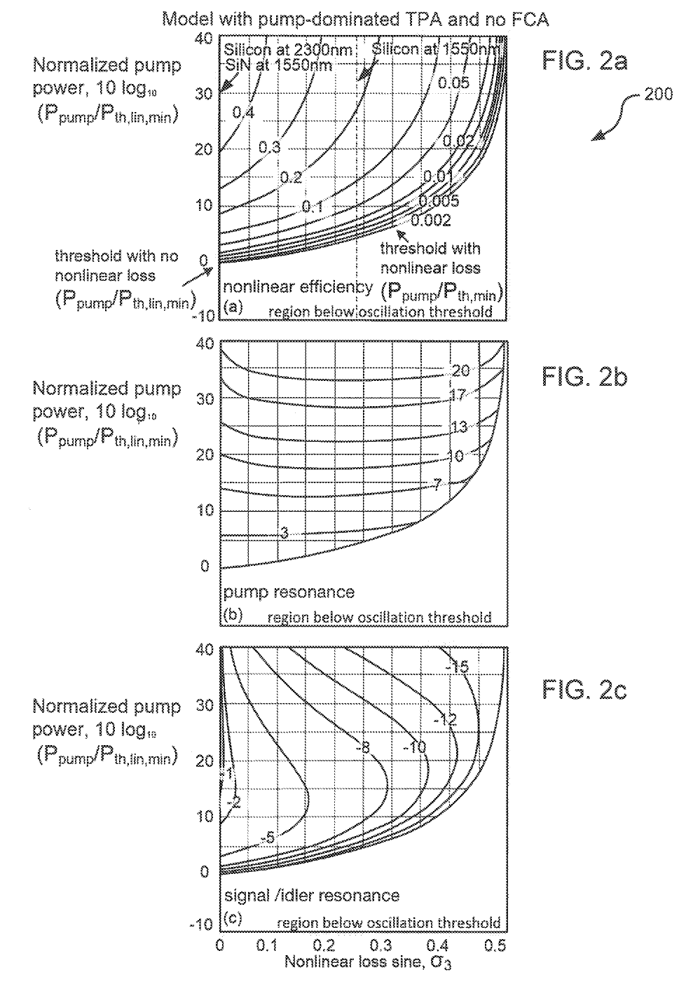

In general, the oscillation threshold depends on the choice of external couplings ρ_{p,ext} and ρ_{s,ext}. Using the present model (i.e., without FCA), the minimum threshold pump power is given by

$${P}_{th , min} = \frac{1 - {σ}_{3}}{{( 1 - 2 {σ}_{3} )}^{2}} \frac{2 {r}_{o}^{2}}{ω {β}_{fwm}} = \frac{1 - {σ}_{3}}{{( 1 - 2 {σ}_{3} )}^{2}} {P}_{th , lin , min} \qquad ( 17 )$$

where P_{th,lin,min} ≡2r₀²/(ωβ_{fwm})=|Sₒ|² is referred to as the linear minimum threshold and represents the minimum threshold pump power when nonlinear loss is negligible (σ₃=0). The threshold scales as V_{eff}/Qₒ², where Qₒ is the linear loss Q (unloaded quality factor), and V_{eff} is the effective nonlinear mode interaction volume defined in Appendix A. The σ₃-dependent prefactor in Equation (17) shows spoiling of the nonlinear loss and defines the nonlinear oscillation threshold curves in FIGS. 2a, 2b, 2c, 4a, 4b, 4c, 8a and 8b.

Given the linear minimum threshold for all σ₃, the design points for the OPO design at all points above the threshold can be determined. In the steady state, the FWM conversion (pump input to signal output) efficiency η is defined as

$$η ≡ \frac{{\vert {S}_{s , -} \vert}^{2}}{{\vert {S}_{p , +} \vert}^{2}} = \frac{2 {r}_{s , ext} {\vert {A}_{s} \vert}^{2}}{{\vert {S}_{p , +} \vert}^{2}} = \frac{2 {ρ}_{s , ext} {\vert {B}_{s , ext} \vert}^{2}}{{\vert {T}_{p , +} \vert}^{2}} . \qquad ( 18 )$$

In this expression, |Bₛ|² can be replaced with an expression that depends on |Bₚ|² and |T_{p.+}|² using Equations (12)-(13). Then, using Equation (16), the FWM conversion (pump input to signal output) efficiency η can be expressed as a function only of the input pump power (T_{p.+}|²), external couplings (ρ_{p,ext} and ρ_{s,ext}), and the nonlinear loss sine σ₃.

A maximum efficiency design can be found by maximizing the efficiency with respect to pump external coupling and then with respect to signal external coupling. From

$$\frac{\partial η}{\partial {p}_{p , ext}} = 0 ,$$

the optimum solution is found as

$${ρ}_{p , ext , opt} = \frac{1 - 2 {σ}_{3}}{1 + {ρ}_{s , ext}} {\vert {T}_{p , +} \vert}^{2} . \qquad ( 19 )$$

This choice of pump coupling ρ_{p,ext} corresponds to a maximum of the FWM conversion (pump input to signal output) efficiency η for a given input pump power |T_{p,+}|² and a signal/idler coupling ρ_{s,ext} Equations (18) and (19) can be used to remove the dependence of η on ρ_{p,ext}. A cubic equation in ρ_{s,ext} can then be determined by setting the derivative of this new η with respect to ρ_{s,ext} (for a given |Tₚ₊₁|²) to zero:

(1+ρ_{s,ext})²(2σ₃ρ_{s,ext}+1−σ₃)−(1−2σ₃)²|T_{p,+}|²=0.

Because the coefficients of this cubic equations are all real, it always has a real root, given by

$${ρ}_{s , ext , opt} = \frac{1}{6 {σ}_{3}} ( - 1 - 3 {σ}_{3} + {( d - E )}^{\frac{1}{3}} + {( D + E )}^{\frac{1}{3}} ) \\ D ≡ {( 3 {σ}_{3} - 1 )}^{3} + 54 {{σ}_{3}^{2} ( 1 - 2 {σ}_{3} )}^{2} {\vert {T}_{p , +} \vert}^{2} \\ E ≡ 3 {σ}_{3} ( 1 - 2 {σ}_{3} ) \sqrt{6 {\vert {T}_{p , +} \vert}^{2} [ {( 3 {σ}_{3} - 1 )}^{3} + D ]} . \qquad ( 20 )$$

The solution of Equation (20) is valid when the input pump power, |S_{p,+}|², is above the minimum threshold power P_{th,min}, which corresponds to the signal coupling ρ_{s,ext,opt} in Equation (20) (and the efficiency η) taking on positive real values.

Thus, Equations (19) and (20) articulate design points for a parametric oscillator in closed form that achieves maximum efficiency η for a given “lossiness” of the 3^{rd}-order nonlinearity being used, described by material dependent nonlinear loss sine σ₃, and a given input pump power, |S_{p,+}|². The design constitutes a particular choice of pump and signal resonance external coupling, providing a maximum conversion efficiency

ηₘₐₓ(|T_{P,+}|²,σ₃)≡η(|T_{p,+}|²,σ₃,ρ_{p,ext,opt},ρ_{s,ext,opt}).

All other parameters that are included in the normalizations (rₒ, Sₒ, and Aₒ), such as the linear losses, four-wave mixing coefficient, confinement of the optical field, etc., scale the solution.

In one design implementation, the limit with no nonlinear loss (σ₃→0) is considered. For σ₃→0, the optimum couplings are

ρ_{s,ext,opt}=\sqrt{|T_{p,+}|²}−1 (21)

ρ_{p,ext,opt}=\sqrt{|T_{p,+}|²}. (22)

This result is consistent with the observation that, if the pump power is near the threshold (but above it), then the amount of signal/idler light generate is small and the system is in the undepleted pump scenario. In this case, the optimum solution is ρ_{p,ext,opt}=1 (and r_{p,ext,opt}=rₒ), which means that the pump resonance is critically coupled. Critical coupling maximizes the intra-cavity pump intensity, and hence the parametric gain seen by the signal and the idler light. In the case where the pump power is well above threshold, the generated signal/idler light carries significant energy away from the pump resonance (which acts as a virtual gain medium to the signal/idler light). As a result, the pump resonance sees an additional loss mechanism. The pump coupling is then larger to match the linear and nonlinear loss combined to achieve “effective critical coupling,” in which case ρ_{p,ext,opt}>1 (and r_{p,ext,opt}>rₒ). For the signal/idler output coupling, near threshold ρ_{p,ext,opt}<<1. Since gain just above threshold exceeds loss by a small amount, the output coupling cannot be large as it would add to the cavity loss and suppress oscillation—hence, the optimal r_{s,ext} is between zero and a small value.

In the case of far-above-threshold operation, \sqrt{|T_{p,+}|²}>>1, and thus ρ_{s,ext,opt}≈ρ_{p,ext,opt}=\sqrt{|T_{p,+}|²}. This also means that r_{s,ext,opt}=r_{p,ext,opt}>>rₒ, such that the output coupling rate is far above the linear-loss rate. In the high-power scenario, the optimum design is then equal coupling.

In the lossless nonlinearity regime, the optimum design's efficiency (i.e., maximum achievable efficiency) is

$${η}_{max} ( {\vert {T}_{p , +} \vert}^{2} , {σ}_{3} = 0 ) ) = \frac{{( \sqrt{{\vert {T}_{p , +} \vert}^{2}} - 1 )}^{2}}{2 {\vert {T}_{p , +} \vert}^{2}} \qquad ( 23 )$$

for |T_{p,+}|²>1 (above threshold). With the optimum efficiency together with the corresponding normalized coupling, Equations (21)-(22) provide all of the information needed to design optimum OPOs employing a lossless χ⁽³⁾ nonlinearity.

For device geometries where different external coupling for different resonances are not easily implemented, the pump and signal/idler couplings can be forced to all be equal, such that ρ_{p,ext}=ρ_{s,ext}≡ρₑₓₜ. For each input pump power, |T_{p,+}^{(ec)}|², there is an optimum choice of coupling, ρₑₓₜ=ρ_{ext,opt}. Above threshold, this coupling maximizes the threshold power. The optimum coupling, ρ_{ext,opt}, is related to the pump power by

$${\vert {T}_{p , +}^{( ec )} \vert}^{2} = \frac{{( 1 + {ρ}_{ext , opt} )}^{3} {( 1 + 2 {ρ}_{ext , opt} )}^{2}}{{{ρ}_{ext , opt} ( 3 + 2 {ρ}_{ext , opt} )}^{2}} . \qquad ( 24 )$$

The normalized oscillation threshold is

$${[ {\vert {T}_{p , +}^{( ec )} \vert}^{2} ]}_{th} = {P}_{th , min} / {P}_{th , lin , min} = \frac{27}{16} ,$$

and the corresponding normalized external coupling is given as

$${ρ}_{ext , opt } = \frac{1}{2}$$

at threshold. The optimum coupling is halfway between the optimum values of ρ_{p,ext,opt}=1 and ρ_{s,ext,opt}=0 at threshold in the unconstrained couplings case. At large pump power, |T_{p,+}^{(ec)}|²>>1, Equation (24) has an asymptotic form for

$${ρ}_{ext , opt} \sim \vert {T}_{p , +}^{( ec )} \vert - \frac{1}{2} ,$$

which is the mean value of the optimum couplings in the unconstrained, unequal-coupling case, ρ_{ext,opt}=(ρ_{p,ext,opt}+ρ_{s,ext,opt})/2.

In contrast to the previously described implementation is considered with non-zero nonlinear loss, σ₃>0. FIGS. 2a, 2b, and 2c illustrate example plots 200 of maximum efficiency ηₘₐₓ and corresponding optimum external coupling rates for the pump and signal/idler, Equations (19) and (20), as a function of the nonlinear loss sine σ₃ and normalized input pump power |T_{p,+}|². The plots 200 show that linear losses do not limit the maximum conversion efficiency but rather merely scale the required input pump power and optimum choice of external coupling coefficients. In the lossless nonlinearity case, σ₃→0, 100% conversion (η=0.5 to each of the signal and idler) can be approached with proper design. In addition, nonlinear loss σ₃ places an upper limit on the maximum conversion efficiency, increases the threshold, and increases power requirements. Furthermore, oscillation is only possible using nonlinear materials that have

$${σ}_{3} < \frac{1}{2} .$$

Above this value, the two-photon absorption loss dominates over the parametric gain, impairing oscillation. Even for

$${σ}_{3} < \frac{1}{2} ,$$

the two-photon absorption losses set an upper bound on the maximum achievable conversion efficiency, given as

$$η < \frac{1}{2} - {σ}_{3} . \qquad ( 25 )$$

Note that this is not a tight bound because it results from consideration of pump-assisted TPA only, and analysis using all TPA contributions will further reduce the maximum conversion and can product a tighter bound.

A few qualitative characteristics of the design points can be observed in the plots of FIGS. 2a, 2b, and 2c. The optimum eternal coupling is largely independent of the nonlinear loss. On the other hand, the ratio of the optimal signal external coupling to the optimal pump external coupling is largely independent of pump power and scales primarily with the nonlinear loss.

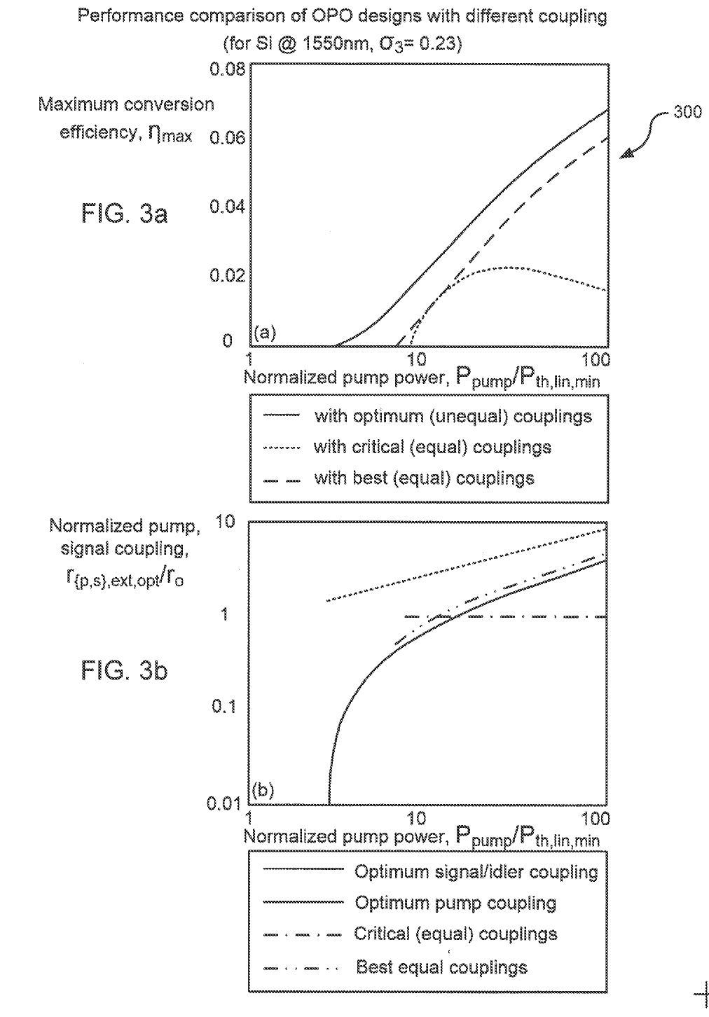

FIGS. 3a and 3b illustrate performance comparisons of OPO designs with optimum unequal pump and signal/idler couplings and with optimized equal couplings (assuming no FCA). With nonlinear loss included, the equal-coupling design is again suboptimal. The minimum normalized oscillation threshold power, for the optimum choice of equal couplings (ρ_{p,ext}=ρ_{s,ext}) is given by

$${P}_{th , min}^{( ec )} = \frac{27 ( 1 - {σ}_{3} )}{16 ( 1 - 2 {σ}_{3} )} {P}_{th , lin , min} . \qquad ( 26 )$$

Equation (26) is valid in the σ₃→0 case with equal couplings. In performance comparison 300, the equal couplings curve crosses the horizontal axis at 6.354, corresponding to Equation (26) with σ₃=0.23 (silicon at 1550 nm). The optimum choice of coupling at threshold is still

$${ρ}_{p , ext} = {ρ}_{s , ext} ≡ {p}_{ext , opt} = \frac{1}{2} .$$

FIGS. 3a, 3b, and 3c also compare the FWM conversion efficiency of the optimal design to one with all three resonances at the usual critical coupling condition, ρ_{p,ext}=ρ_{s,ext}=ρ_{i,ext}=1. FIGS. 3a, 3b, and 3c also illustrate the case where the couplings are all equal but are optimized at each value of input power, as calculated above. The curves show that an unequal coupling design outperforms one with equal couplings. Further, the curves show that the critical coupling condition, though it maximizes intracavity pump power and is reasonably close to the optimal design at low powers, is far from optimal for above threshold and does not reach maximum conversion efficiency.

In another implementation, the single-cavity, traveling wave model may be generalized to include full TPA, including that involving only resonance signal/idler light photons, which applies to systems in the regime of a lossy χ⁽³⁾ nonlinearity, excluding treatment of FCA. It can be assumed in this model that free carrier lifetime can be low enough to not be the limiting loss. The loss rates of Equation (3) have the form

ρ_{s,tot}=1+ρ_{s,ext}+2σ₃(|Bₛ|²+|Bₚ|²+2|Bᵢ|²)

ρ_{p,tot}=1+ρ_{p,ext}+2σ₃(2|Bₛ|²+|Bₚ|²+2|Bᵢ|²)

ρ_{i,tot}=1+ρ_{i,ext}+2σ₃(2|Bₛ|²+|Bₚ|²+|Bᵢ|²). (27)

There is no longer a simple closed-form expression for the in-cavity steady-state pump light energy. Instead, the in-cavity steady-state pump light energy may be represented as

$${\vert {B}_{p} \vert}^{2} = \frac{( 1 + {ρ}_{s , ext} + 6 {σ}_{3} {\vert {B}_{s} \vert}^{2} )}{2 ( 1 - 2 {σ}_{3} )} \qquad ( 28 )$$

which depends on the in-cavity steady state signal/idler light energy, |Bₛ|². The steady-state |Bₛ|² can be found by solving

4(1−2σ₃)³ρ_{p,ext}|T_{p,+}|²=(6σ₃|Bₛ|²+1+ρ_{s,ext})·[(1−2σ₃)(1+ρ_{p,ext})+σ₃(1+ρ_{s,ext})+2(2−5σ₃²)|Bₛ|²]² (29)

by numerically sweeping across the values of the parameters ρ_{p,ext} and ρ_{p,ext} to find the maximum conversion efficiency.

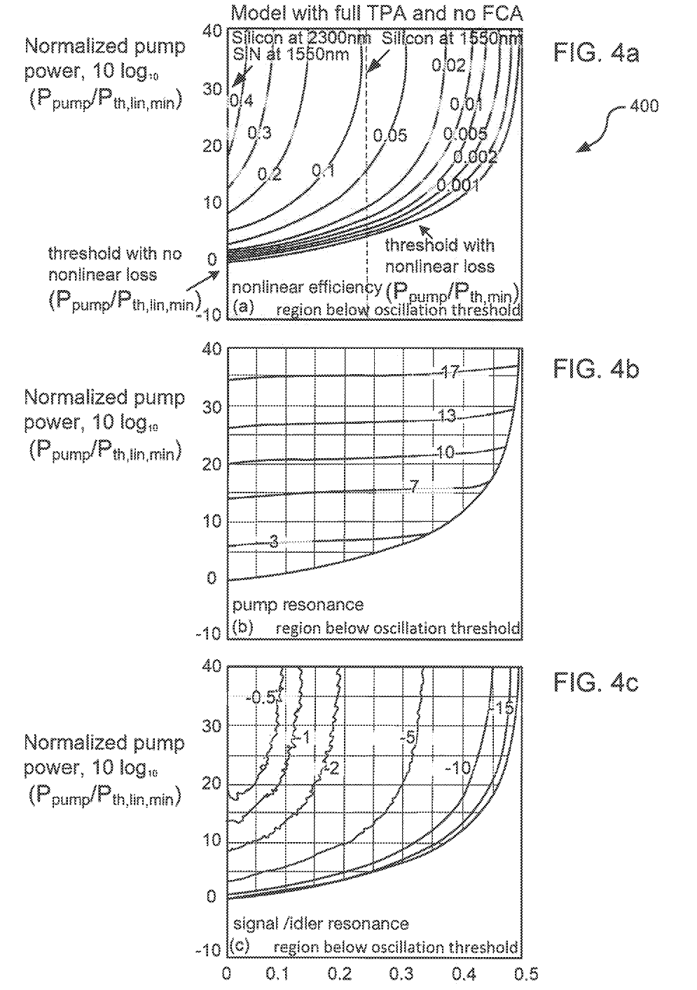

FIGS. 4a, 4b, and 4c illustrate example normalized design curves 400 for optimum OPO design when all TPA terms are included (without FCA). Design curve (a) depicts maximum conversion efficiency (numbered curves) versus pump power (y-axis) and nonlinear loss sine (x-axis). Design curve (b) depicts optimum pump coupling (numbered curves) versus pump power (y-axis) and nonlinear loss sine (x-axis). Design curve (c) depicts the ratio of signal/idler coupling to pump resonance coupling (numbered curves) versus pump power (y-axis) and nonlinear loss sine (x-axis).

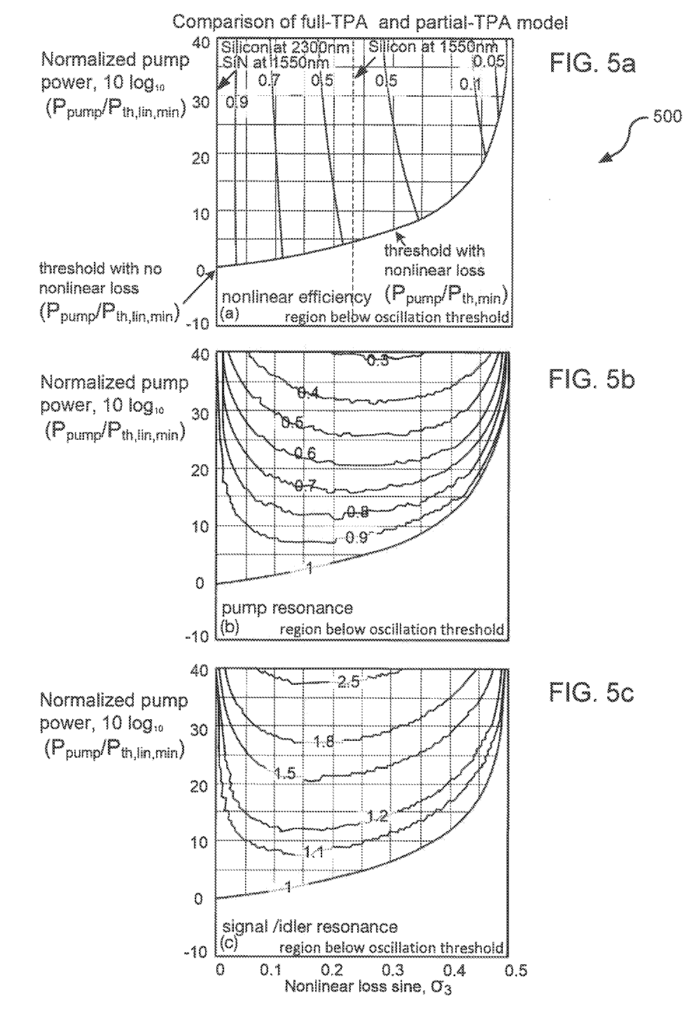

FIGS. 5a, 5b, and 5c illustrate a comparison 500 between two example cases, one with partial (pump-assisted only) TPA and the other with full TPA. Design curve (a) depicts maximum conversion efficiency ratio (numbered curves) versus pump power (y-axis) and nonlinear loss sine (x-axis). Design curve (b) depicts optimum pump coupling ration (numbered curves) versus pump power (y-axis) and nonlinear loss sine (x-axis). Design curve (c) depicts the ratio of signal/idler coupling (numbered curves) versus pump power (y-axis) and nonlinear loss sine (x-axis)—all values are full TPA case divided by partial TPA case.

The normalized optimum solution can be used to derive the optimum performance limitations of a few relevant systems, including OPOs based on silicon and silicon nitride microcavities. The Kerr (related to parametric gain) and TPA coefficients for crystalline Si and Si₃N₄ are given in Table 1.

TABLE 1
Predicted performance of optical parametric oscillators
based on a single-ring cavity with a traveling wave mode

| | | n₂^{b} | | | | | | | | | |
|---|---|---|---|---|---|---|---|---|---|---|---|
| Non- | | (10⁻⁵ | β_{TPA}^{b} | | | W × H^{c} | | | | β_{fwm} | |
| linear | λ | cm²/ | (cm²/ | | | (nm) × | Rₒᵤₜ^{c} | Qₒ^{dI} | V_{eff}^{e} | (10⁶ | Pₜₕ^{g} |
| Material^{a} | (μm) | GW) | GW) | NFOM | σ₃ | (nm) | (μm) | (10⁶) | (μm³) | J⁻¹) | (mW) |
| c-Si | 1.55 | 2.41 | 0.48 | 0.34 | 0.23 | 460 × 220 | 3 | 1 | 2.1 | 29 | 0.055 |
| c-Si | 2.3 | 1.0 | ≈0 | ∞ | ≈0 | 700 × 250 | 7 | 1 | 10 | 2.5 | 0.16 |
| a-SI:H | 1.55 | 16.6^{f} | 0.49^{f} | 2.2 | 0.036 | 460 × 220 | 3 | 1 | 2.1 | 186 | .0004 |
| Si₃N₄ | 1.55 | 0.24 | ≈0 | ∞ | ≈0 | 1600 × 700 | 15 | 1 | 84 | 0.22 | 2.8 |

^{a}Defines waveguide core medium; devices use silica cladding (n = 1.45) surrounding the waveguide core
^{b}The Kerr coefficient n₂ and TPA coefficient β_{TPA} are related to material χ⁽³⁾:
$\frac{ω}{c} {n}_{2} + \frac{1}{2} {β}_{TPA} = \frac{3 ω}{4 {ɛ}_{0} {c}^{2} {n}_{nl}^{2}} {χ}_{1111}^{( 3 )} .$ ^{c}The cavity dimensions in this table are merely examples and are not intended to limit the scope of any claimed invention. Here, W, H, and Rₒᵤₜ are waveguide core width, height, and ring outer radius.
^{d}Qₒ is cavity quality factor due to linear loss (it is assumed that Qₒ = 10⁶ in the example designs).
^{e}V_{eff} is effective overlap volume of the signal, pump and idler modes, which are three consecutive longitudinal modes of a microring.
^{f}For a-Si:H, the Kerr coefficient n₂ = A_{eff}γ_{R}/kₒ and TPA coefficient β_{TPA} = 2A_{eff}γ_{I}.
^{g}Assuming no FCA

Example materials having third-order nonlinearity include without limitation silicon, a III-V semiconductor, silicon nitride, aluminum nitride, a glass, diamond, or a polymer.

In the telecommunication band at 1.55 μm wavelength, Si has a large nonlinear loss due to TPA (σ₃≈0.23), while Si₃N₄ has negligible TPA (σ₃≈0) but an order of magnitude smaller Kerr coefficient. An alternative implementation involves pumping silicon above λ˜2.2 μm (i.e., photon energy below half the bandgap in silicon), offers both high Kerr coefficient and near zero TPA). In yet another implementation, hydrogenated amorphous silicon has a comparably high NFOM of 2.2 at λ=1.55 μm (σ₃≈0.036).

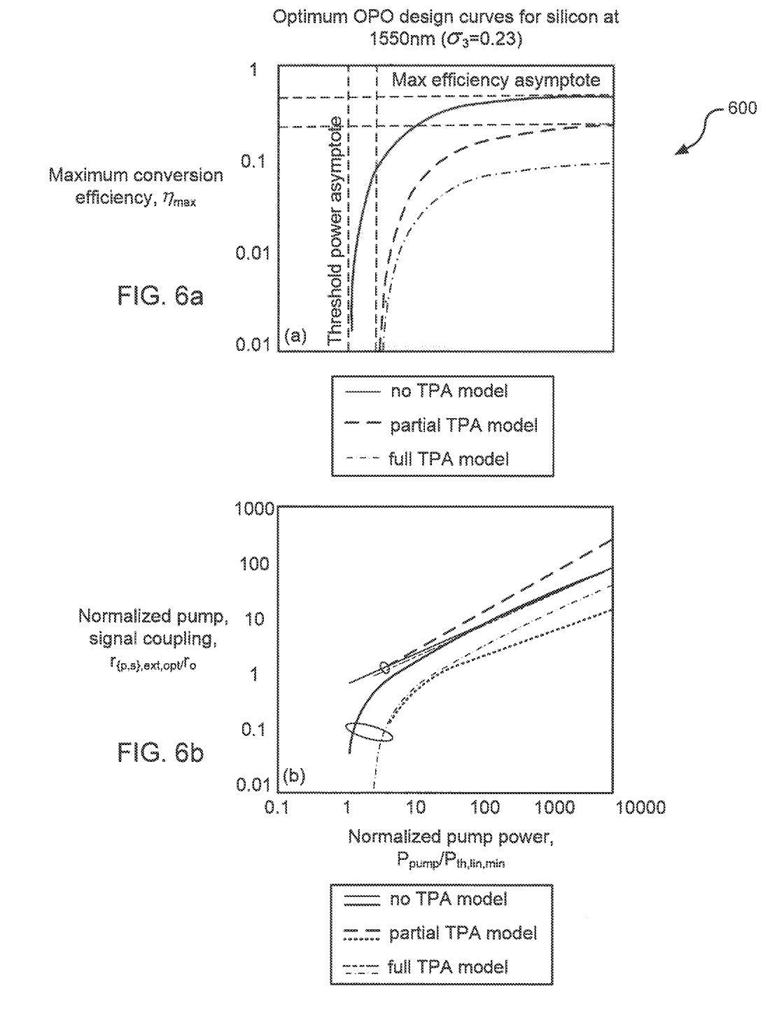

FIG. 6 illustrates example OPO design curves 600 for nonlinear media with and without TPA loss (assuming no FCA). The design curves 600 effectively depict slices through FIGS. 2a, 2b, 2c, 4a, 4b and 4c showing the still normalized conversion efficiency and corresponding external coupling for optimum designs versus pump power for no TPA loss, representative of silicon nitride at 1550 (σ₃≈0) and silicon pumped at 2.3 μm; for partial TPA of the 1550 nm silicon design (σ₃≈0.23); and for full TPA loss.

To estimate the conversion efficiency and threshold pump power for these reference designs, and to provide some non-normalized example numbers, some typical microring cavity design parameters, given in Table, have been assumed, and a single ring cavity design has been modeled. For example, for a silicon (n=3.48) microring resonant near λ=1550 nm with an outer radius of 3 μm, a 460×220 nm² waveguide core cross-section, surrounded by silica (n=1.45), the quality factor of the lowest TE mode due to bending loss is 1.7×10⁷. Considering other linear losses (e.g., sidewall roughness loss), a total linear loss Q of 10⁶ is assumed. The effective volume is 2.1 μm³, the FWM coefficient is β_{fwm}≈2.9×10⁷ J⁻¹, and the minimum linear threshold power, P_{th,lin,min}, is 21 μW, while the full minimum nonlinear threshold, with no FCA, is 55 μW.

In a number of χ⁽³⁾ materials, including silicon, fee carrier absorption (FCA) can be a substantial contributor to optical nonlinear losses. FCA can be negligible with sufficient carrier sweep out in the presence of strong applied electric fields. In general, however, with no or incomplete carrier sweep out, FCA is present.

To solve for the steady-state in-cavity signal light energy (with FCA), the steady-state solution for Bₛ satisfies

σ₃ρ′_{FC}Bₚ⁴+(8σ₃ρ′_{FC}Bₛ²+4σ₃²)Bₚ²=−(6σ₃ρ′_{FC}Bₛ⁴+6σ₃Bₛ² (30)

[(2−2σ₃)Bₚ²+(4+2σ₃)Bₛ²+ρ_{p,ext}−ρ_{s,ext}]²Bₚ²=2ρ_{p,ext,opt}T_{p,+}² (31)

The steady state solution for Bₛ can be solved numerically to find the optimum coupling for maximum conversion efficiency by sweeping the parameter space. As can be noted from Equation (9), the loss due to free carrier absorption (FCA), which affects the conversion efficiency η, scales with the ratio

$$\frac{{τ}_{FC}}{{Q}_{o}} ,$$

i.e., the ratio of free carrier lifetime to cavity photon lifetime.

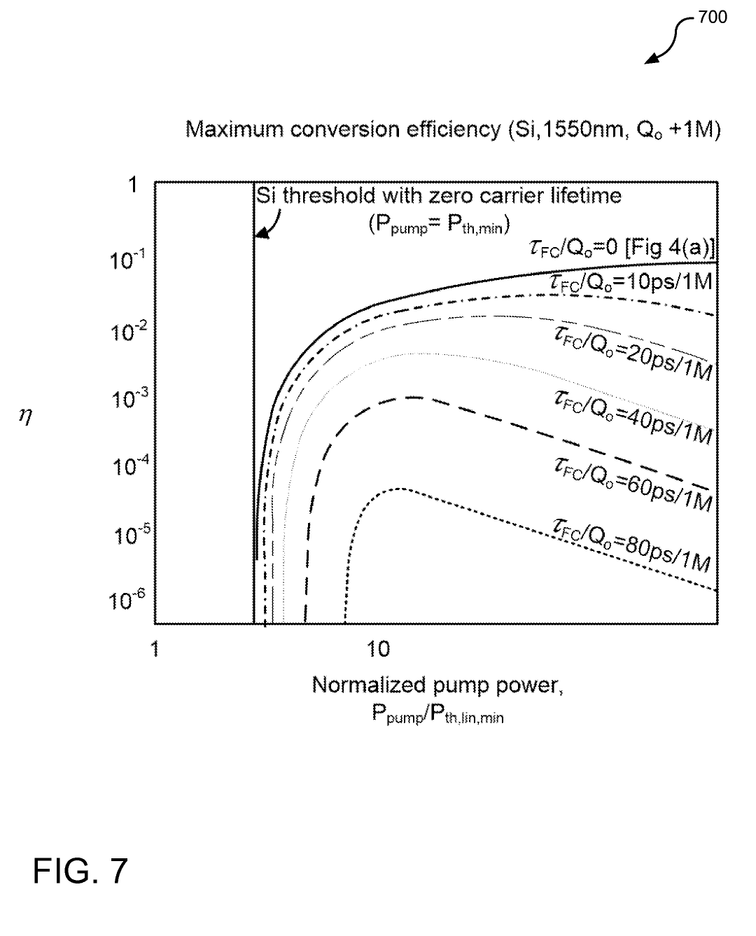

FIG. 7 illustrates performance 700 of an example silicon microcavity at 1500 nm resonance with various free-carrier lifetimes and intrinsic cavity quality factors. The performance 700 depicts simulation results for the silicon microcavity at 1550 nm in Table 1 with an example set of free carrier lifetimes and cavity loss Q values. The performance 700 shows that, with FCA present, the optimum design's conversion efficiency, ηₘₐₓ, does not monotonically increase with input pump power, because a stronger pump produces a larger steady-state carrier concentration generated by TPA and, as a result, the overall FCA and total cavity loss is higher at higher pump power. The free carrier loss increases faster (quadratically with pump power), leading to falling conversion efficiency with increasing pump power. FIG. 7 also shows that even silicon OPOs at 1550 nm, where TPA and FCA work against the nonlinear conversion process, can achieve conversion efficiencies of 0.1% with a pump power of 0.21 mW and free carrier lifetime of 60 ps, which is well within the achievable using carrier sweep out via e.g., a reverse biased p-i-n diode integrated in the optical microcavity.

A closed form expression for the minimum oscillation threshold when FCA is present is given by

$${P}_{th , min} = \frac{4 ( 1 - {σ}_{3} )}{{[ ( 1 - 2 {σ}_{3} ) + \sqrt{{( 1 - 2 {σ}_{3} )}^{2} - {σ}_{3} {ρ}_{FC}^{′}} ]}^{2}} {P}_{th , lin , min} \qquad ( 32 )$$

and depends on the nonlinear loss sine σ₃, and normalized free-carrier-lifetime, ρ′_{FC}.

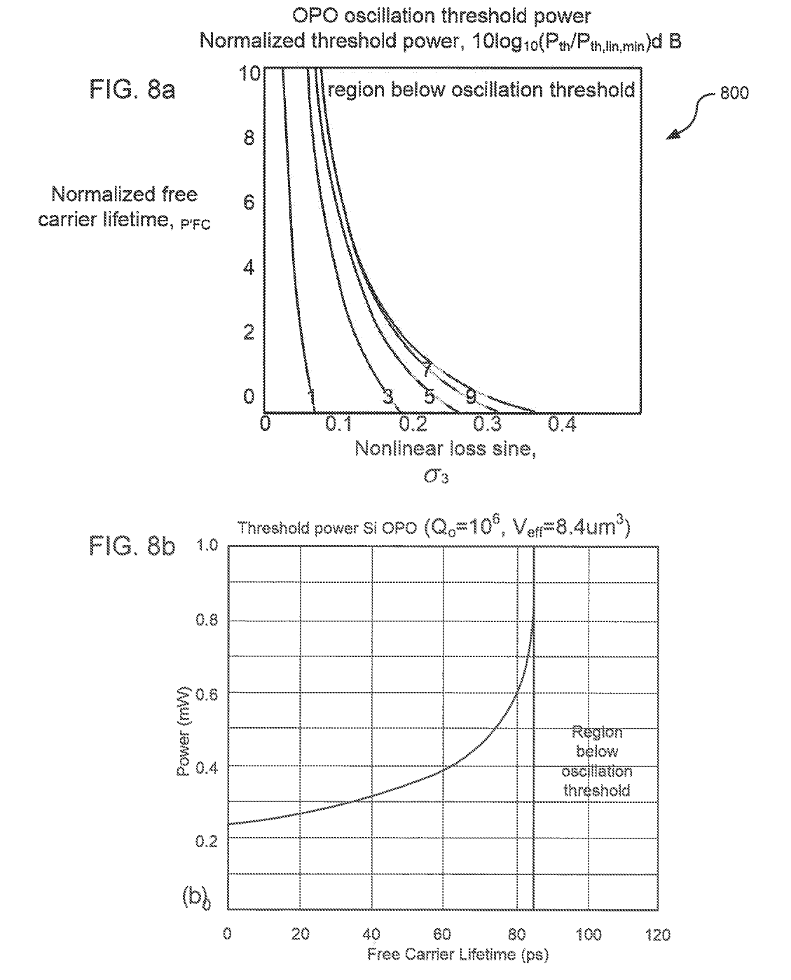

FIG. 8 illustrates an OPO threshold versus (a) normalized free carrier lifetimes and σ₃; and (b) free carrier lifetime for a silicon cavity resonant near 1550 nm with linear unloaded Q of 10⁶ and effective volume of 8.4 μm³. Plot (a) shows the minimum OPO threshold versus the nonlinear loss sine σ₃ and normalized free-carrier lifetime ρ′_{FC}. Plot (b) shows the minimum OPO threshold for a silicon cavity near 1550 nm versus actual free carrier lifetime.

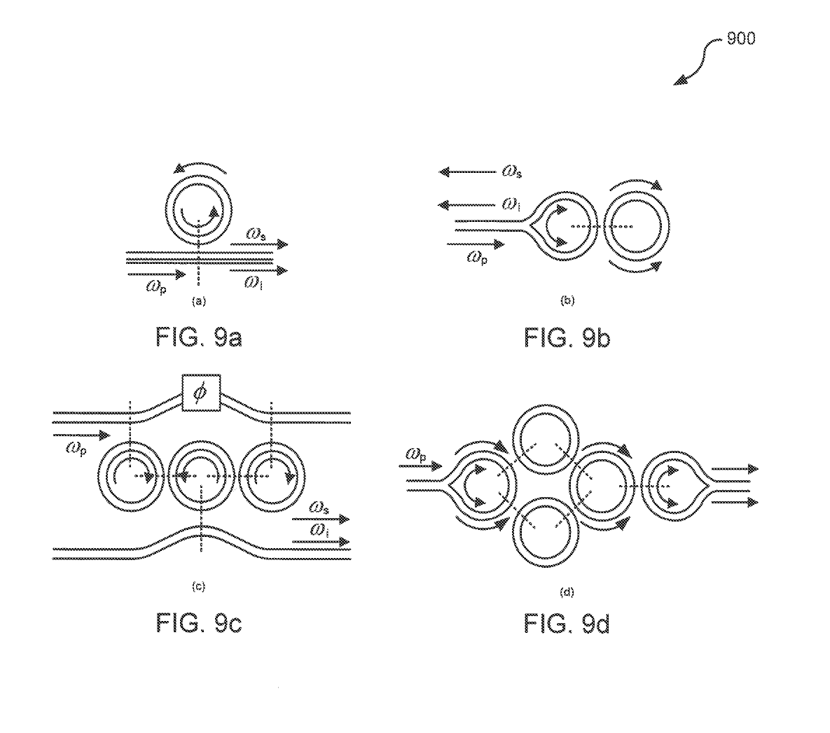

FIGS. 9a, 9b, 9c, and 9d illustrate examples of various microphotonic coupled-resonator structure topologies 900. The triple-cavity resonator shown in FIG. 1 c and FIG. 9c is one example of a resonator that explicitly provides 3 resonant modes near each longitudinal resonance of the constituent microring cavities. In some implementations, the cavities can be circular (as shown), oval, in the shape of a solid disk, and other possible shapes. The wavelength spacing of these resonances is determined by ring-ring coupling strengths, which depend on the coupling gap. If the dispersion in the building-block microring cavity is sufficiently large, adjacent longitudinal resonances that are spaced 1 free spectral range (FSR) from the utilized resonance will not have proper frequency matching and will not exhibit substantial FWM as a result. Thus, the nonlinear optics can be confined to the “local” three resonances formed by ring coupling at one longitudinal order. One benefit of the triple-cavity design is that, even if the microring cavity is dispersive and has non-constant FSR, the coupling-induced frequency splitting can be designed to provide equally spaced resonances to enable FWM. As a result, the individual microring cavity can be optimized for parametric gain, without a competing requirement to produce zero dispersion, while the coupling provides the choice of output signal/idler wavelengths. By contrast, in a single microcavity, the choice of wavelengths is directly coupled to the size as is parametric gain, so minimizing the mode volume also incurs signal/idler wavelengths that are spaced far apart due to the large FSR and may put a limit on how small the cavity can be made and still provide a benefit, as dispersion may begin to work against the increase in parametric gain.

Based on the described models and example topologies, efficient resonant photonic devices can be designed. Such devices, such as those shown in microphotonic coupled-resonator structure topologies 900, can include an optical resonator (e.g., a single cavity or a triple cavity configuration) supporting three resonant frequencies. The optical resonator is formed from a material having third-order optical nonlinearity. One or more waveguides are coupled to each of the three resonant modes. An optical input port of one of the waveguides is more strongly coupled to a first of the resonant modes than to either of the two other resonant modes. An optical output port of one of the waveguides is more strongly coupled to at least one of the other resonant modes than to the first resonant mode. The third-order optical nonlinearity causes a gain in the second and third resonant modes and a loss in the first resonant mode. The frequencies of the three resonant modes are all within one free spectral range.

Referring again to the triple-cavity resonator shown in FIG. 1 c and FIG. 9c, the bottom waveguide couples only to the signal and idler resonance modes because only the signal and idler resonance modes have non-zero intensity in the middle ring cavity. If the phase shift 0 is chosen so that excitation of the first and last rings (the left-most and right-most rings) are out of phase for the signal/idler resonances, then the first and last rings will not be excited. Since the pump resonance has antisymmetric amplitudes in the outer rings, unlike the signal and idler, which have symmetric amplitudes, the pump will be efficiently excited by the same configuration, with coupling string controlled by the choice of coupling gaps (e.g., coupling strength is dependent upon the coupling gap between waveguides/resonators). In this manner, the coupling to the pump, and to the signal and idler wavelengths, is decoupled. The waveguide resonator coupling gap in each case determines the corresponding linewidth, allowing different pump and signal/idler couplings to be implemented. Note that, in the design of FIG. 1 c and FIG. 9c, the pump resonance is coupled only to the top waveguide, and the signal/idler resonance is coupled only to the bottom waveguide. Therefore, in the linear regime, the top and bottom waveguide are decoupled, and the only energy coupling from the top to the bottom waveguide can come from nonlinear interaction.

To simplify the analysis, the six distinct TPA coefficients, β_{tpa,mn}, by four—after making the assumption that the frequency splitting Δω=ωₚ−ωₛ=ωᵢ−ωₚ is small, and that signal and idler mode confinement is similar, the effective two-photon absorption coefficients are about the same (β_{tpa,ii}=β_{tpa,ss} and β_{tpa,tp}=β_{tpa,sp}).

As shown in Appendix A, the four wave mixing coefficients β_{fwm,k} (kε{s,p,i}) and two photon absorption coefficients β_{tpa,mn} (m, nε{s, p, i}) are dependent on the overlap integral of interacting cavity modes. For different cavities, these coefficients and their relative magnitudes can be very different. As an example, FIGS. 9a, 9b, 9c, and 9d depict resonators consisting of a single ring cavity or triple coupled ring cavities, each with either traveling-wave mode or standing-wave mode excitation. In one example, the ratio of signal-idler TPA to parametric gain (i.e., σ₃dₛᵢ) is larger in a triple-ring resonator than in a single-ring resonator, with a traveling-wave mode excitation. Accordingly, the effective figure of merit of the triple-ring resonator is smaller than that of the single-ring cavity. A summary of the various FWM coefficients and d-vectors is shown in Table 2.

TABLE 2
Comparison of FWM and TPA
coefficients in various cavity topologies

| Cavity Type^{a} | ${\frac{{β}_{fwm}}{{β}_{fwm} ( 1 - ring , TW ) )} }^{b}$ | dₛₛ | dₚₚ | dₛₚ | dₛᵢ |
|---|---|---|---|---|---|
| 1-ring | 1 | 1 | 1 | 1 | 1 |
| (TW^{c}) | | | | | |
| 3-ring | ¼ | 3/2 | 2 | 1 | 3/2 |
| (TW^{c}) | | | | | |
| 1-ring | ½ | 3 | 3 | 2 | 2 |
| (TW^{c}) | | | | | |
| 3-ring | ⅜ | 3/2 | 2 | 1 | 3/2 |
| (TW^{c}) | | | | | |

^{a}Each constituent ring of the triple-ring cavity is identical to the single-ring cavity
^{b}Four wave mixing coefficients are normalized to that of a single-ring cavity with traveling-wave modes.
^{c}TW: traveling wave; SW: standing-wave

Table 3 shows the results of Table 1 evaluated for a 3-coupled cavity “photonic molecule” OPO with traveling-wave excitation, based on the same ring cavity design in each case.

TABLE 3
Predicted performance of optical parametric oscillators based
on 3-ring photonic molecule with traveling-wave mode

| Nonlinear | λ | V_{eff}^{a} | β_{fwm} | Pₜₕ |
|---|---|---|---|---|
| Material | (μm) | (μm³) | ₍₁₀⁶ J⁻¹) | (mW) |
| c-Si | 1.55 | 8.3 | 7.2 | 0.29 |
| c-Si | 2.3 | 40 | 0.63 | 0.65 |
| s-Si:H | 1.55 | 8.3 | 46 | 0.015 |
| Si₃N₄ | 1.55 | 337 | 0.05 | 11 |

^{a}Each constituent ring of the triple-ring cavity is identical to the single-ring cavity in Table 1

The cavity envelope (the distribution of the field across parts of the compound resonator, as well as standing versus traveling wave excitation) impacts performance. Specifically, standing-wave excitation is very efficient for self-TPA loss terms, such as absorption of two signal photons or two pump photons. On the other hand, because of differences in longitudinal mode order, the parametric gain is partially suppressed. Thus, standing-wave excitation in general performs less favorably to traveling-wave excitation in the presence of TPA. Likewise, the single-ring configuration is more efficient than the triple ring configuration with traveling-wave excitation. However, with standing-wave excitation, the single-ring resonator has a larger FWM coefficient but, at the same time, larger TPA loss (d coefficients). It should be understood, however, that this comparison is for microring cavities being equal. The triple ring design may be able to use much smaller ring cavities than a single ring design, as it is not limited by dispersion. Therefore, either configuration may be efficient, depending on implementation, target wavelengths, etc.

In summary, the model presented provides a normalized solutions versus normalized pump power (including linear losses), nonlinear FOM σ₃ and a normalized FCA, for each resonator “topology” with a unique d-vector.

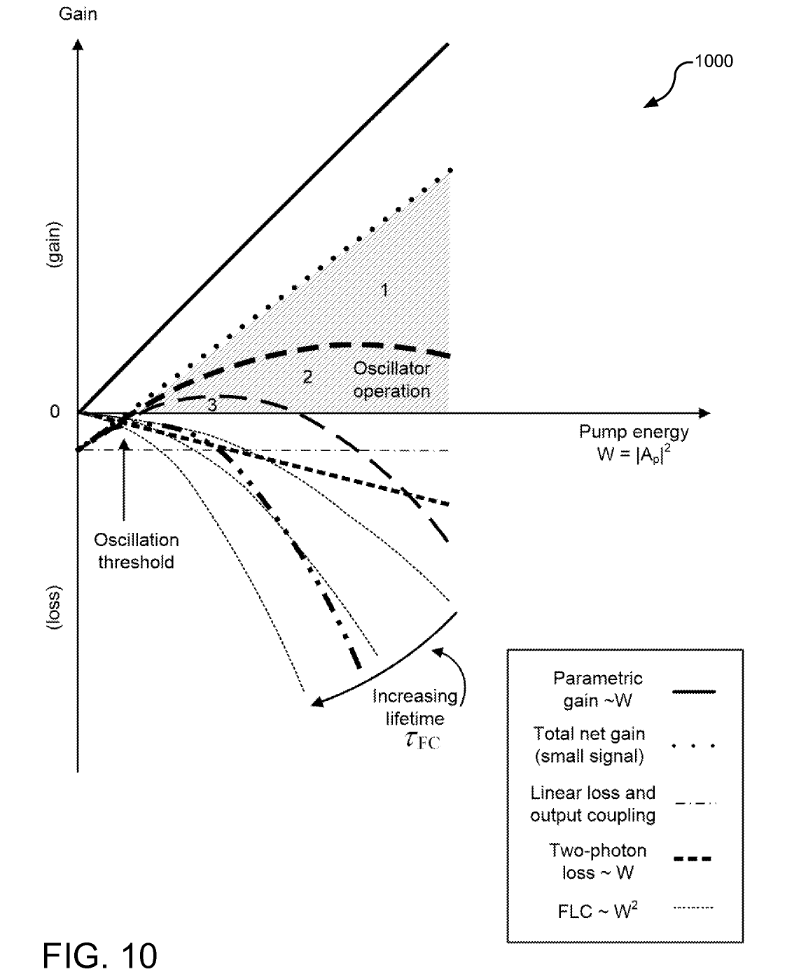

FIG. 10 illustrates an example model 1000 of small signal gain and loss in an optical parametric oscillator based on degenerate four wave mixing (FWM). The minimum threshold pump power of optical parametric oscillation in a single ring cavity with traveling-wave mode is derived from Equations (12) (13):

T_{p,+}=j(\sqrt{2ρ_{p,ext}})(ρ_{p,tot}+8ρ_{i,tot}⁻¹|Bₛ|²|Bₚ|²)B_{P} (33)

When the input pump power is just above threshold, the OPO starts lasing, |Bₛ|²≈0, and thus

$${\vert {T}_{p , +} \vert}^{2} = \frac{{ρ}_{p , tot}^{2}}{2 {ρ}_{p , ext}} {\vert {B}_{p} \vert}^{2} . \qquad ( 34 )$$

The threshold pump power is the smallest pump power that can make the OPO oscillate. To minimize threshold, external couplings for pump, signal, and idler are chosen to minimize the expression for pump power in Equation (34). The pump power is minimized at

ρ_{p,ext}=1+2σ₃|Bₚ|²+σ₃ρ′_{FC}|Bₚ|⁴ (35)

and

Pₜₕ=(2(1+2σ₃|Bₚ²+σ₃ρ′_{FC}|Bₚ|⁴)|Bₚ|²)ₘᵢₙ. (36)

From Equations (11) and (12), |Bₚ|² can be minimized using

2|Bₚ|²=ρ_{s,tot}=1+ρ_{s,ext}+4σ₃B|Bₚ|²+σ₃ρ′_{FC}|B_{P}|⁴ (37)

By solving this quadratic equation, the smaller root is given by:

$${\vert {B}_{p} \vert}^{2} = \frac{( 1 - 2 {σ}_{3} ) - \sqrt{{( 1 - 2 {σ}_{3} )}^{2} - {σ}_{3} {ρ}_{FC}^{′} ( 1 + {ρ}_{s , ext} )}}{{σ}_{3} {ρ}_{FC}^{′}} . \qquad ( 38 )$$

To minimize |Bₚ|², we have ρ_{s,ext}=0 and an upper limit of normalized FCA loss for OPO to oscillate:

$${ρ}_{FC}^{′} \leq \frac{{( 1 - 2 {σ}_{3} )}^{2}}{{σ}_{3}} . \qquad ( 39 )$$

By combining Equations (36) and (38), the threshold pump is given as

$${P}_{th} = \frac{4 ( 1 - {σ}_{3} )}{{( ( 1 - 2 {σ}_{3} ) + \sqrt{{( 1 - 2 {σ}_{3} )}^{2} - {σ}_{3} {ρ}_{FC}^{′}} )}^{2}} . \qquad ( 40 )$$

When there is no FCA loss limit (π′_{FC}→0), the threshold pump power simplifies to Equation (17). This choice of external coupling corresponds to maximum parametric gain (the largest in-cavity light energy for given input pump power) and the smallest loss rate for the signal and idler light.

For the case of equal pump and signal/idler coupling (ρ_{p,ext}=ρ_{s,ext}=ρₑₓₜ), Equations (34) and (37) can be combined to give:

$${\vert {T}_{p , +} \vert}^{2} = \frac{{ρ}_{p , tot}^{3}}{4 ( 1 - {σ}_{3} ) {ρ}_{ext}} \qquad ( 41 )$$

where

$${ρ}_{ext} = {ρ}_{p , tot} - 1 - 2 {σ}_{3} {\vert {B}_{p} \vert}^{2} - {ρ}_{FC}^{′} {\vert {B}_{p} \vert}^{4} , {\vert {B}_{p} \vert}^{2} = \frac{{p}_{s , tot}}{2} = \frac{{ρ}_{p , tot}}{2 - 2 {σ}_{3}} ,$$

and then the threshold pump power can be represented by a function of ρₑₓₜ. This expression is complex but can be simplified when FCA is ignored:

$${P}_{th}^{′} = \frac{{( 1 - {σ}_{3} )}^{2}}{4 ( 1 - 2 {σ}_{3} )} \frac{{( 1 + {ρ}_{ext} )}^{3}}{{ρ}_{ext}} {\vert}_{min} = \frac{27 {( 1 - {σ}_{3} )}^{2}}{16 {( 1 - 2 {σ}_{3} )}^{3}} \qquad ( 42 )$$

with ρₑₓₜ=½ at threshold.

The example model 1000 provides a physical interpretation of the oscillation threshold when both linear loss and nonlinear loss are present, illustrating various terms of small-signal gain and loss for the signal resonance in an optical parametric oscillator based on degenerate four wave mixing. The linear loss rate, including material absorption, scattering loss, radiation loss, and external coupling, etc., is independent of the in-cavity pump energy, which roughly scales with input pump power. The parametric gain from four wave mixing, and loss due to two photon absorption are both proportional to pump energy. However, their scaling factors vary by a factor of 2σ₃, resulting in oscillation for a nonlinear material with σ₃<0.5.

The loss due to free carrier absorption scales with the square of the pump energy, as shown in FIG. 10. When loss due to free carrier absorption is ignored, the total net gain is greater than 0 in region 1. As the effective free carrier lifetime increases, the parabolic curve becomes steeper, and the region of positive net gain shrinks to region 2 and region 3. When the free carrier lifetime is above a certain limit, the total net gain is negative.

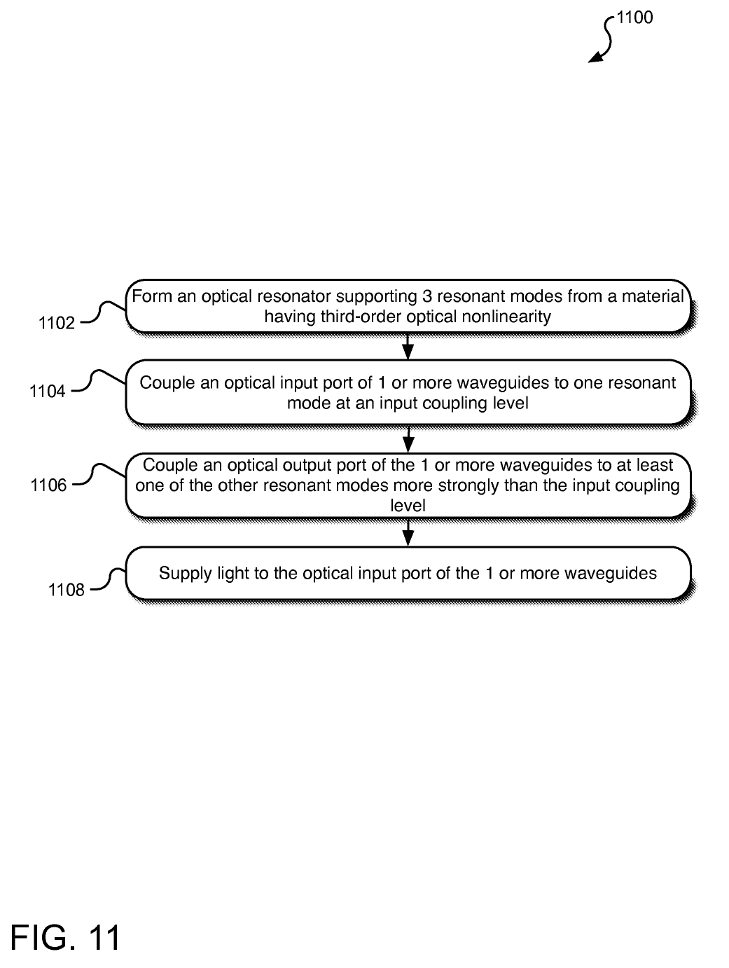

FIG. 11 illustrates example operations 1100 for making and using an optical parametric oscillator based on degenerate four wave mixing (FWM). A construction operation 1102 forms an optical resonator supporting three resonant modes. The optical resonator is formed from a material having third-order optical nonlinearities (e.g., Si, SiN₄). A coupling operation 1104 couples an optical input port of one or more waveguides to one of the resonant modes (the first resonant mode) at an input coupling level. Another coupling operation 1106 couples an optical output port of the one or more waveguides to at least one of the other resonant modes more strongly than the input coupling level (e.g., more strongly than the optical input port is coupled to the first resonant mode). A pumping operation 1108 supplies light to the optical input port.

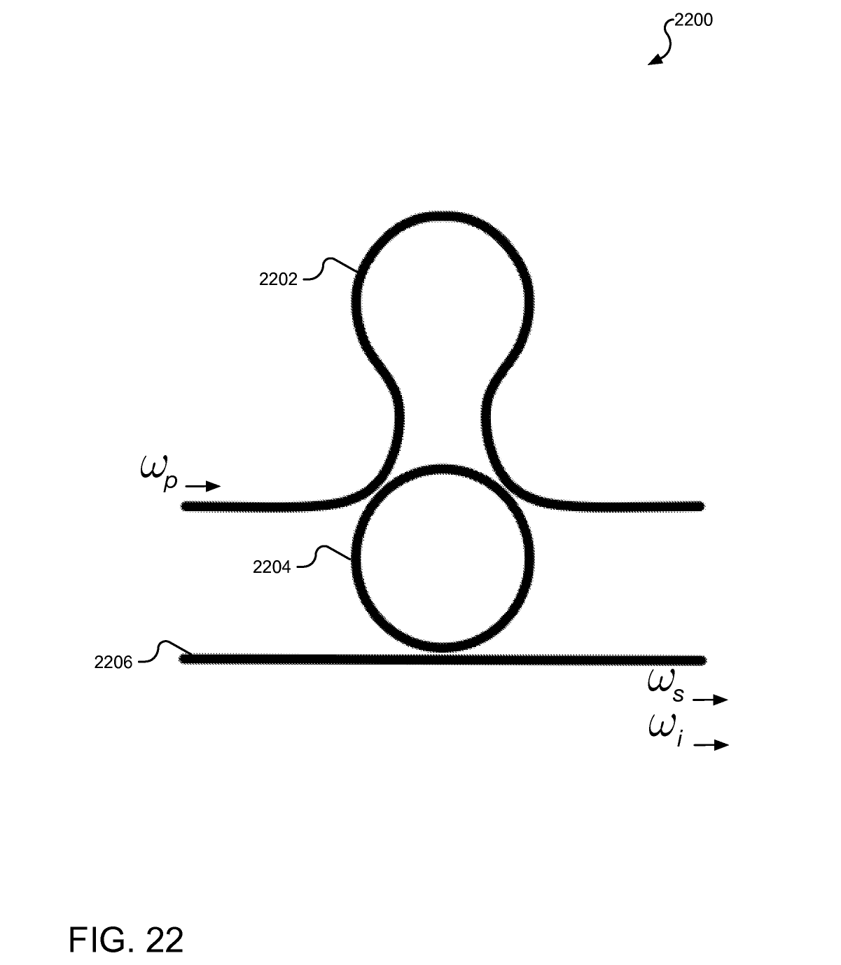

FIG. 22 illustrates another example resonant photonic device topology 2200. A waveguide 2202 includes an optical waveguide input port receiving a signal having a pump resonant frequency ωₚ, and an waveguide 2206 includes an optical waveguide output port outputting signals having signal and idler resonant frequencies, ωₛ and ωᵢ, respectively. An optical resonator having a microcavity 2204 is directly coupled to both of the waveguides 2202 and 2206.

The optical input waveguide port is more strongly coupled to a resonant mode of the microcavity 2204 tuned on resonance with a pump wavelength than to resonant modes of the microcavity 2204 tuned on resonance with signal or idler wavelengths. The optical output waveguide port is more strongly coupled to a resonant mode of the microcavity 2204 tuned on resonance with one or both of the signal or idler wavelengths than to a resonant mode of the microcavity 2204 tuned on resonance with a pump wavelength.

With regard to on-chip microphotonic filter banks for use in WDM, many photonic communication links and network implementations employ wavelength (de)multiplexers typically comprising serially cascaded microring filter stages. Microring filters have a free spectral range (FSR) that is determined by the ring circumference and the guided mode group index, relating to dispersion. In a WDM communication link, the free spectral range (FSR), adjacent channel rejection and required filter bandwidth with certain maximum insertion loss determine how many WDM channels can fit in one FSR of the microring-based filters. The total bandwidth (and bandwidth utilization, Gbps data/GHz optical bandwidth) increases with an increasing number of WDM channels in a given optical wavelength range. Accordingly, higher order filter responses permit denser channel spacing. Higher order filters, however, involve a larger number of microring resonators, which increases thermal tuning to compensate for fabrication variations and to align to a WDM grid. Thermal tuning has substantial energy cost and significantly impacts the energy efficiency of a proposed photonic link design.

In one implementation, a cascade of a number of stages of a filter design that enables asymmetric response shapes (referred to as a “pole-zero” filter) enables very dense wavelength channel packing using low-order filters, denser by a factor of 2.4 than conventional Butterworth designs of the same order when using second-order stages.

To design a pole-zero add-drop filter, placement of the resonant frequencies (poles) and transmission zeros of the filter response is controlled in the complex-frequency plane. Introduction of a zero on one side of the passband in the complex-frequency plane yields an asymmetric filter response. In one implementation, a coupling-of-modes-in-time (CMT) model is used to design a photonic system with the desired filter response, including the shape of the passband and the location of the transmission zero. A general photonic system is described to achieve one finite-detuning transmission zero in the drop port. A solution to the CMT equations for an N^{th}-order system is also described. In one specific example implementation, a 2^{nd}-order implementation for which the CMT model is rigorously derived along with a solution for the full design equations.

Note that in the CMT model, a single resonance per resonant cavity is considered. Accordingly, a single pole or some number of zeros refers in a real cavity to a certain number per mode (i.e., per FSR of the system). Narrowband approximation (e.g., the passband is much smaller than the FSR) is assumed, so that the adjacent azimuthal modes do not contribute to the same passband. However, these constraints are artificial and the same approach can be applied if a single cavity is used to supply multiple resonances that contribute to the passband, for example.

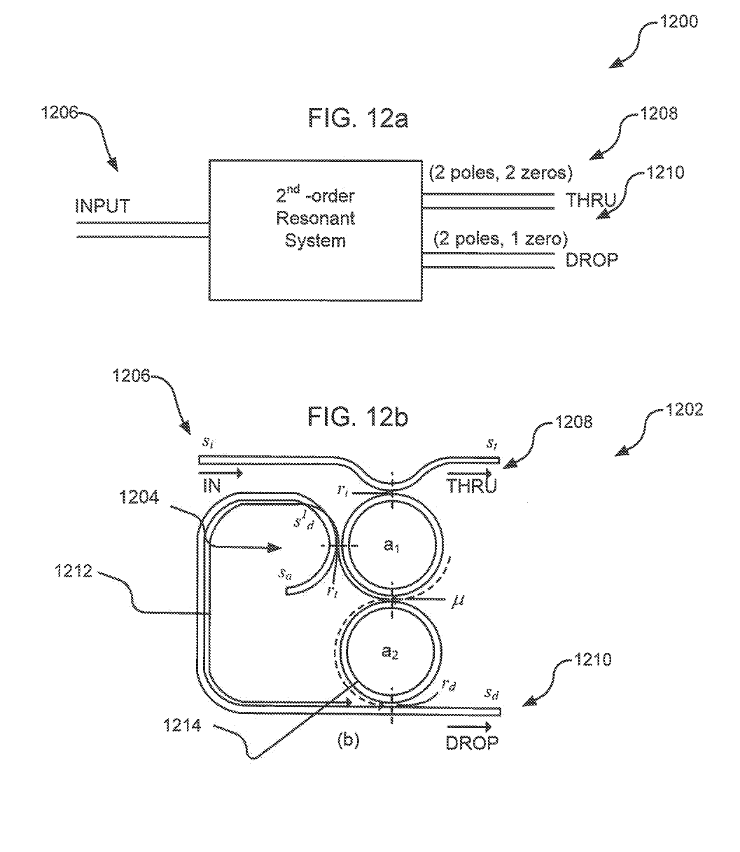

FIGS. 12a and 12b illustrate an example 2^{nd}-order resonance system 1200 capable of a 2-pole, 1-zero response and a schematic implementation 1202 of the system 1200 that employs a weak tap coupler 1204 to give rise to interference that produces the transmission zero. The abstract photonic circuit of system 1200 represents a filter with one input port 1206 and two output ports, a through (or thru) port 1208 and a drop port 1210. Since the system 1200 has two resonances, all of the ports share the same two poles in the complex-frequency plane. The ports can have 0 to N finite-detuning transmission zeros (where N is the number of poles in the system). Assuming a lossless system, the system 1200 is constrained to have two real zeros in the thru port 1208 to ensure 100% transmission at those frequencies in the drop-port passband by power conservation, with a second-order rolloff. A real zero is added in the drop port transfer function, placed on one side of the passband to make the response function asymmetric.

A physical implementation 1202 of the photonic circuit can achieve the desired asymmetric response, where aₖ is the energy amplitude in the kₜₕ ring; r_{i,d,t} are the decay rates in the input bus, drop bus, and tap coupling, respectively; sᵢ is the amplitude of the input wave; sₐ is the amplitude of an additional input wave (or add-port input wave); s_{d} is the amplitude of the drop-port-output wave; s′_{d} is the amplitude of the wave coupled out of aₗ; sₜ is the amplitude of the through-port-output wave, μ represents the choice of ring-ring coupling. A rule can be used to determine the number of finite-detuning transmission zeros in the response function from the input to a given output port (i.e., in each s-parameter, S_{j,input}, jε{thru, drop}). In general, the number of finite transmission zeros in each s-parameter is equal to N, the resonant order of the system 1200, minus the minimum number of resonators that are optically traversed from input waveguide to output waveguide. Using this rule as a guide, the circuit order of the system N=2, and the minimum number of resonators that light passes through is one to the drop port 1210 and zero to the through port 1208.

In the drop port response, the light can take the path 1212 through the tap coupler 1204, bypassing the second resonator 1214 (a₂). Using the general rule, this configuration results in: (2 poles)-(1 minimum resonator traversed to drop)=1 transmission zero in the drop port response. Similarly, two zeros are found in the through port response, which creates the familiar rejection band in the same way as for serially coupled ring filters.

Because the transmission zero is placed off resonance, to enhance the drop-port response rejection band, it is possible to find a simple model for the position of the transmission zero, by assuming off-resonant excitation of the resonances in the system 1200. The time evolution of the mode energy amplitudes in a lossless N^{th} order system of serially coupled resonators can be written as N first order differential equations,

$$\frac{d}{d t} {a}_{1} = ( {jω}_{1} - {r}_{1} ) {a}_{1} - j {μ}_{12} {a}_{2} - j \sqrt{2 {r}_{i}} {s}_{i} \\ \frac{d}{d t} {a}_{2} = {jω}_{2} {a}_{2} - {jμ}_{21} {a}_{1} - {jμ}_{23} {a}_{3} \\ ⋮ \\ ⋮ \\ ⋮ \\ \frac{d}{d t} {a}_{N} = ( {jω}_{N} - {r}_{d} ) {a}_{N} - {jμ}_{( N ) ( N - 1 )} {a}_{N - 1} - j \sqrt{2 {r}_{d}} {s}_{d} \qquad ( 43 )$$

where aₖ is the energy amplitude in the k^{th} ring; ωₖ is the resonant frequency of the k^{th} ring; r_{i,d} are the decay rates to the input bus and drop bus, respectively; μ_{id} represents the choice of ring-ring couplings; sᵢ is the amplitude of the input wave; and s_{d} is the amplitude of the drop-port-output wave. If the resonant frequencies of all rings are set equal, as is the case for typical square passband responses, the desired filter shape is synthesized through choice of the ring-ring couplings, μₖₗ, and the input and drop port decay rates, rᵢ and r_{d}.

When a monochromatic input wave is sufficiently far detuned in wavelength from the passband center wavelength, the coupling in each equation is dominated by the forward coupling from one ring to another (i.e., μ_{(N)(N+1)}a_{N+1}|/| μ_{(N)(N-1)}a_{N-1}<<1). A reason for this behavior is that, off-resonance, the rings resist the exchange of energy (e.g., when the detuning is much larger than the coupling rate), so coupling from ring 1 to ring 2 is weak, and from ring 2 back to ring 1 is weaker still because it is a second-order effect in the detuning-induced suppression of coupling. Hence, in the coupling Equations (43), the dominant coupling is assumed from the ring energy amplitude that is closer to the input bus 1206. As such, Equations (43) are simplified by the complete decoupling of the individual equations, and Equations (43) recovers the response in the off-resonant wings of the passband.

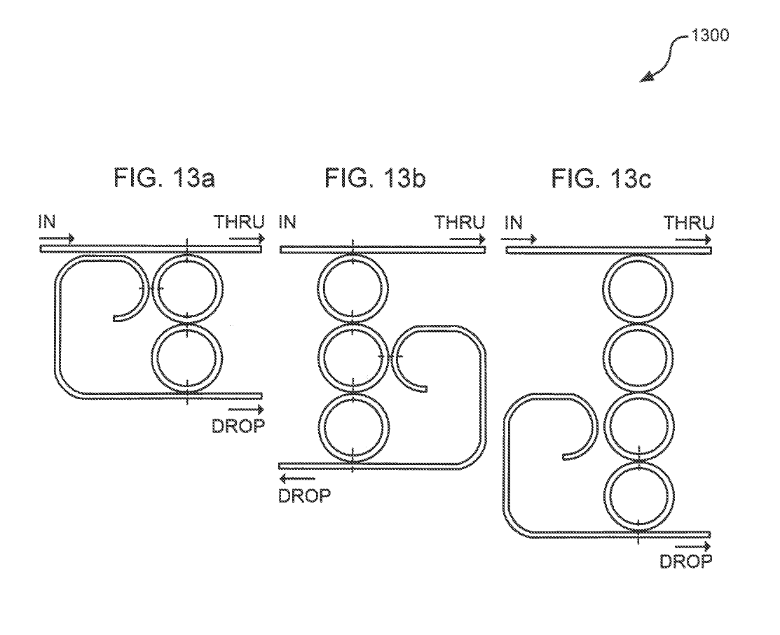

FIGS. 13a, 13b, and 13c illustrate a variety of example higher-order filters 1300, 1302, and 1304, each with a drop-port transmission zero. Filter 1300 represents a 2^{nd} order filter, filter 1302 represents a 3^{rd} order filter, and filter 1304 represents a 4^{th} order filter. In each filter 1300, 1302, and 1304, bypassing the N^{th} ring with a tap at the (N−1)^{th} ring coupled directly to the drop port enables the asymmetric response by ensuring a single drop-port response function zero. The weaker the tap coupling, the further detuned the transmission zero is from the passband.

Equations (43), with one modification, can be solved for the asymmetric response of the filters 1300, 1302, and 1304. The modification is an additional term that describes the direct coupling of the drop port to the (N−1)^{th} ring. After further making the forgoing off-resonant approximation (i.e., that the energy amplitude aₖ is excited primarily by the previous energy amplitude aₖ₋₁), Equations (43) can be given as

$$\frac{d}{d t} {a}_{1} = j ( {ω}_{1} - j {r}_{1} ) {a}_{1} - j \sqrt{2 {r}_{i}} {s}_{i} \\ \frac{d}{d t} {a}_{2} = j {ω}_{2} {a}_{2} - j {μ}_{21} {a}_{1} \\ ⋮ \\ \frac{d}{d t} {a}_{N - 1} = {jω}_{N - 1} {a}_{N - 1} - {jμ}_{( N - 1 ) ( N - 2 )} {a}_{N - 2} - {r}_{t} {a}_{N - 1} \\ \frac{d}{d t} {a}_{N} = j ( {ω}_{N - 1} - j {r}_{d} ) {a}_{N} - j {μ}_{( N ) ( N - 1 )} {a}_{N - 1} - j \sqrt{2 {r}_{d}} {s}_{d}^{′} {e}^{- j φ} \qquad ( 44 )$$

where rₜ is the decay rate to the tap port, φ is the propagation phase accumulated in the interference arm, and s′_{d} is given by

s′_{d}=j\sqrt{2r₁}a_{N-1} (45)

The output wave, s_{d}, can be found from

s_{d}=s′_{d}e^{-jφ}−j\sqrt{2r₁}a_{N} (46)

Letting d/dt→jω to solve for the steady state frequency response of the system 1200, Equations (44)-(46) can be solved for the transfer function, S_{d,i}(ω)=s_{d}sᵢ (valid off resonance)

$$\frac{{s}_{d}}{{s}_{i}} = \frac{{μ}_{N - 2}}{j δ {ω}_{N - 1} + {r}_{t}} ( {\prod }_{k = 1}^{N - 3} \frac{{μ}_{k}}{jδ {ω}_{k + 1}} ) \frac{- j \sqrt{2 {r}_{i}}}{jδ {ω}_{1} + {r}_{i}} ( \frac{\sqrt{2 {r}_{d}} ( {jμ}_{N - 1} + 2 \sqrt{{r}_{d} {r}_{t}} {e}^{j φ} )}{jδ {ω}_{N} + {r}_{d}} - \sqrt{2 {r}_{t}} {e}^{- jφ} ) . \qquad ( 47 )$$

The root of the numerator in Equation (47) gives the frequency position of the transmission zero, which, since it is off resonant, can be found from this approximate model. Setting the imaginary part of the root to zero to place the transmission zero on the real frequency axis and introducing δω_{zd} as the desired detuning from the passband (resonant) frequency to the transmission zero, two design equations can be derived that give the phase delay for the interference arm as well as the decay rate to the tap port:

$$\begin{matrix}cos φ = \frac{δ {ω}_{zd}}{\sqrt{{δω}_{zd}^{2} + {r}_{d}^{2}}} & ( 48 ) \\ {r}_{t} = \frac{{r}_{d} {μ}_{N - 1}^{2}}{{r}_{d}^{2} + δ {ω}_{zd}^{2}} . & ( 49 )\end{matrix}$$

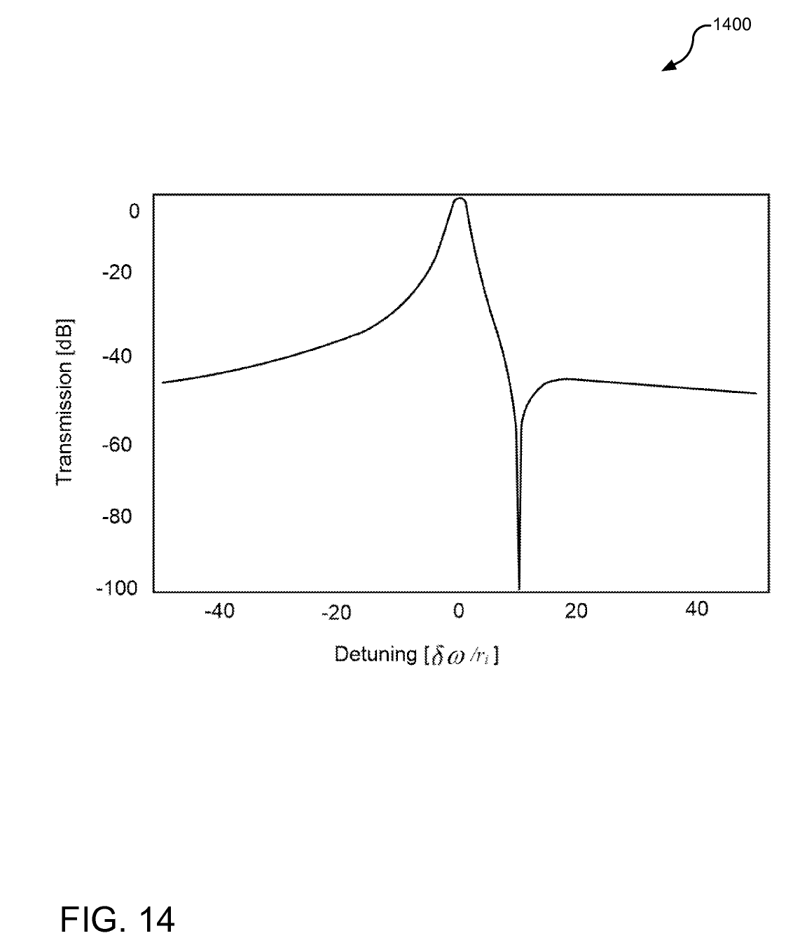

The remaining decay rates and ring-ring couplings can be taken from the standard all-pole design synthesis techniques. FIG. 14 illustrates an example response of a 2^{nd}-order filter and a zero placed at δω_{zd}/rᵢ=10, based on Equations (48) and (49).

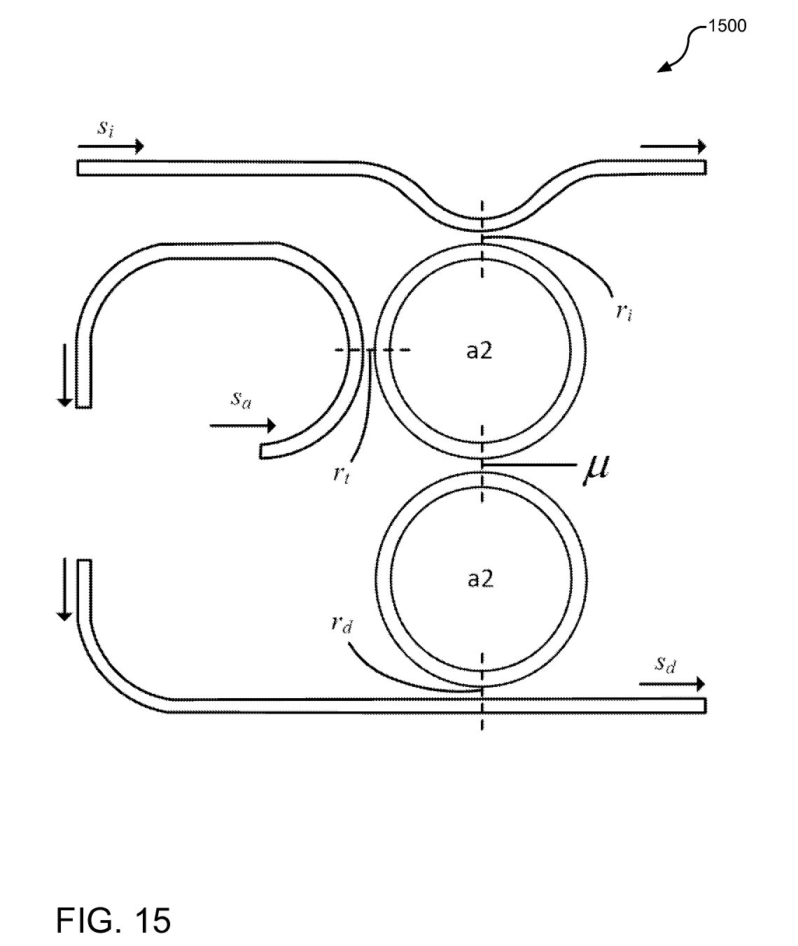

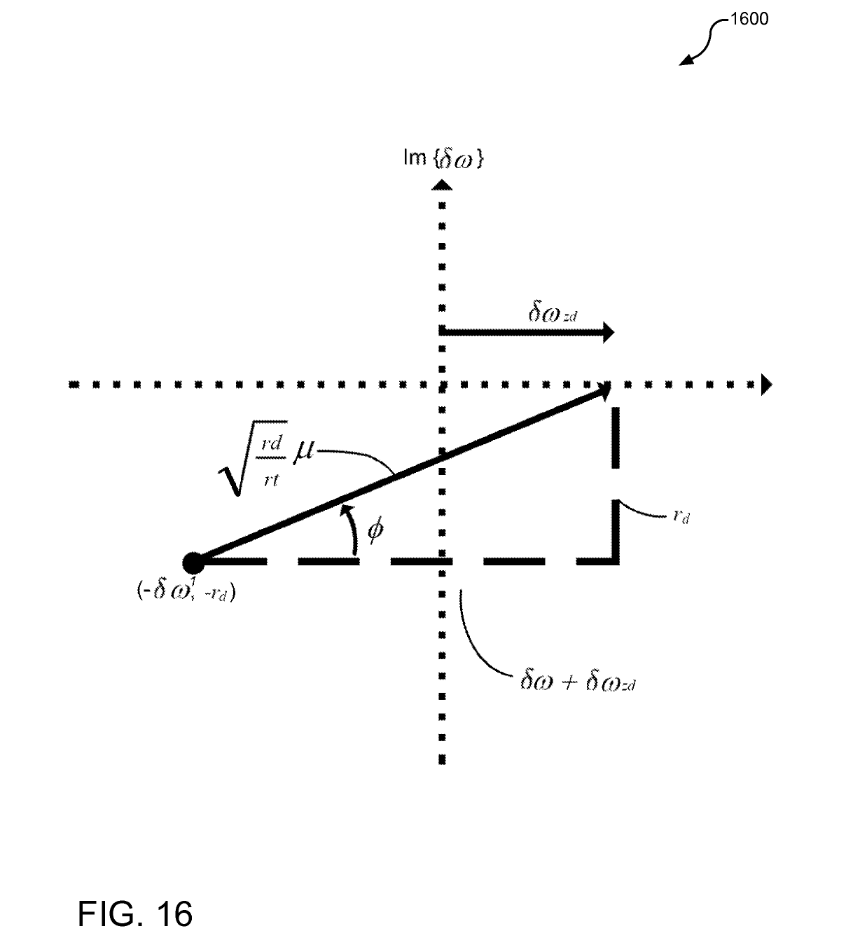

FIG. 15 illustrates an abstract photonic circuit 1500 used to derive the T-matrix of a tapped filter. The approximate design leading to Equations (48) and (49) show that a finite transmission zero in the drop port can be achieved with a proper choice of the tap decay rate and the interference phase and is valid when the transmission zero is placed far from the resonant frequency. However, when it is desirable to place the transmission zero close to the resonant frequency, the approximate design may be invalid, yet full design equations may still be derived using a 3×3 system (i.e., 3 input ports and 3 output ports) having a tap port that is not connected to the drop port, as shown in FIG. 15. FIG. 16 illustrates an example graphical representation 1600 of a drop-port zero location in the complex-δω plane. Using the 3×3 system of FIG. 15, as characterized by the representation 1600 of FIG. 16, the total list of parameters for a pole-zero filter includes rᵢ, μ, δω_{zd}, rₜ, r_{d}, δω′, and φ. The first three parameters (rᵢ, μ, and δω_{zd}) are chosen to be inputs to the model. The choice of rᵢ and μ largely determines the passband shape (maximally flat, equiripple, bandwidth, etc.), and these exist in all-pole (serially-coupled) ring filters. Detuning δω_{zd} is the desired location of the drop port zero. Without loss of generality, rᵢ and μ are chosen here to be those of an all-pole 2^{nd}-order Butterworth filters, such that rᵢ=μ, although other input parameters may be employed. After the three input parameters are chosen, the remaining parameters may be solved using the following derived expressions:

$$\begin{matrix}{r}_{d} - {r}_{i} + {r}_{t} = 0 & ( 50 ) \\ {r}_{t} = \frac{{μ}^{2} {r}_{d}}{\sqrt{{( δ {ω}^{′} + δ {ω}_{zd} )}^{2} + {r}_{d}^{2}}} & ( 51 ) \\ {δω}^{′} = - \frac{2 \sqrt{{r}_{d} {r}_{t}} μ cos φ}{{r}_{d} + {r}_{i} - {r}_{t}} & ( 52 ) \\ cos φ = \frac{δ {ω}^{′} + δ {ω}_{zd}}{\sqrt{{( δ {ω}^{′} + δ {ω}_{zd} )}^{2} + {r}_{d}^{2}}} & ( 53 )\end{matrix}$$

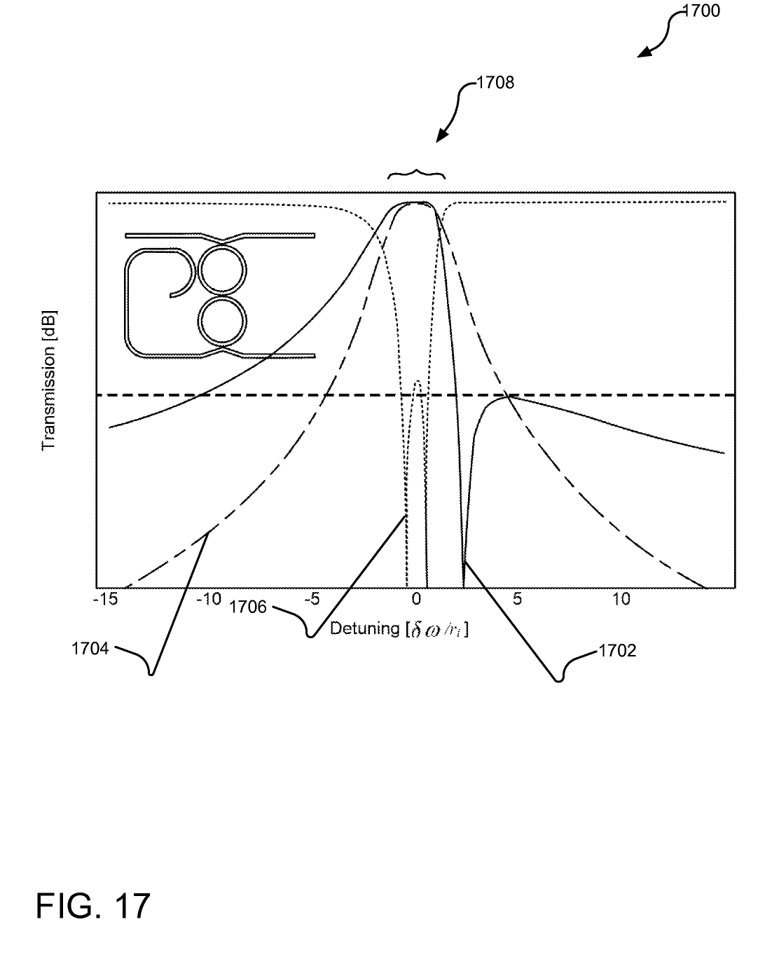

FIG. 17 illustrates a comparison 1700 of an example pole-zero filter with an asymmetric drop response 1702 and an all pole Butterworth filter response 1704. The thru response 1706 is also shown. Notice the transmission zero in the asymmetric drop response 1702 at approximately 2.3, outside of the range 1708 of the two poles.

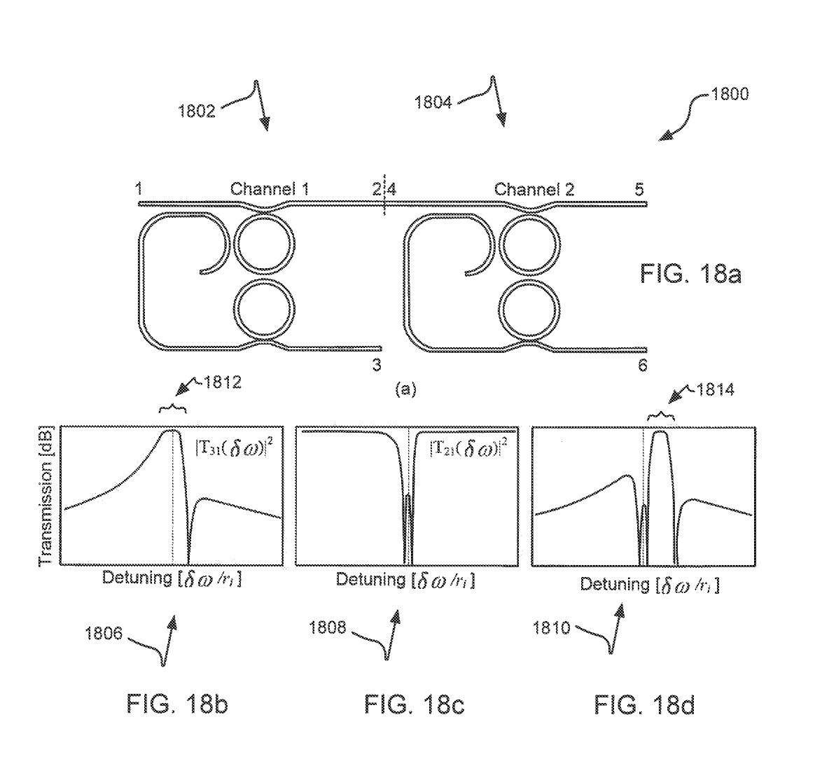

FIGS. 18a, 18b, 18c, and 18d illustrate an example serial demultiplexer 1800 with symmetrized, densely packed passbands by using asymmetric response filters 1802 and 1804 and associated responses 1806, 1808, and 1810. In the drop port response of the pole-zero filters, the transmission rolls off more slowly than a standard 2^{nd} order Butterworth response on the left side of the passband, and it rolls off much faster on the right side between the center frequency and the transmission zero location. To the right of the transmission zero location, the transmission increases again. In general, there is a tradeoff between how close a zero is to the passband (allowing a shaper rolloff) and a worst-case off-resonant rejection out-of-band. In an implementation of the example serial demultiplexer 1800, this affects the adjacent channel rejection. The zero location in FIG. 17, for example, was chosen to achieve a minimum 20 dB adjacent channel rejection.

Using the asymmetric-response filter as a building block, the serial demultiplexer 1800 can be designed to achieve a symmetrized response in the drop port that has fast rolloff on both sides of the center frequency. The asymmetric response filters 1802 and 1804 are coupled in series. The response 1806 illustrates the Channel 1 drop port response, |T₃₁|², with a transmission zero to the right of the two poles 1812 (the passband of Channel 1). The response 1808 illustrates the Channel 1 through port response, |T₂₁|². The response 1810 illustrates the Channel 2 drop port response, |T₆₁|², with a highly selective response due to the transmission zero on the right of the two poles 1814 (the passband of Channel 2), and through-port extinction in the previous stage filter 1802. Accordingly, the through port response 1808 of the Channel 1 filter 1802 shapes the left side of the drop port response 1810 at the Channel 2 filter 1804. In one implementation, this output is achieved when the channel spacing is set equal to the detuning of the zero from the passband center.

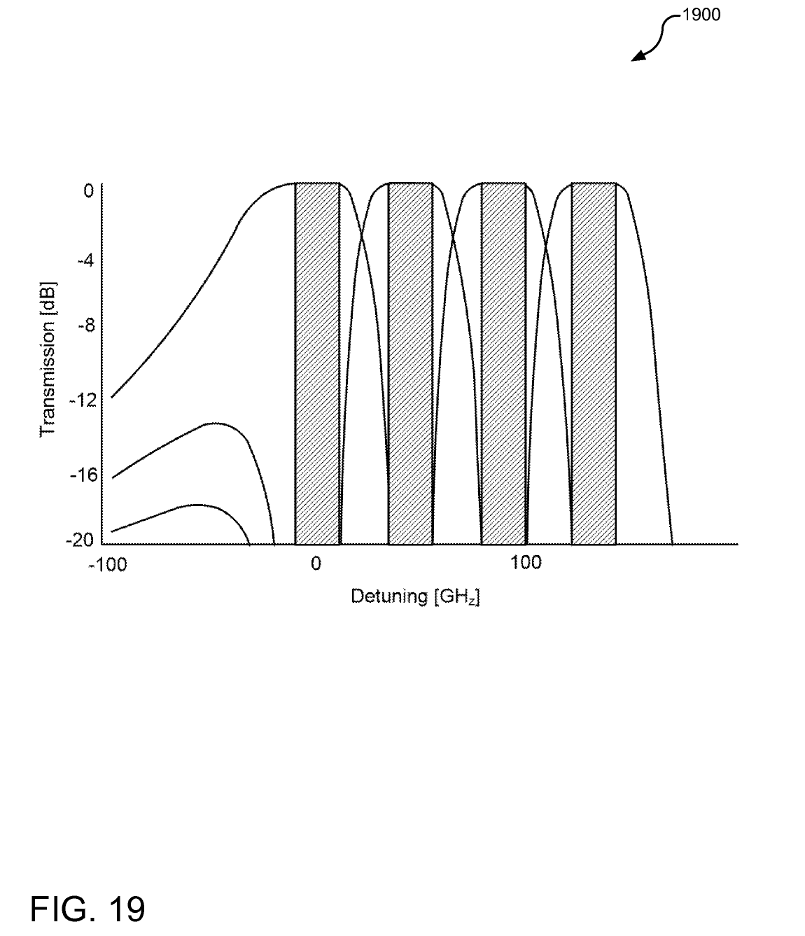

FIG. 19 illustrates drop port responses 1900 from an example demultiplexer design using pole-zero filters showing 20 GHz passbands with 44 GHz channel spacing. The drop port responses 1900 illustrate how each successive channel has a resonant frequency that is detuned from the previous channel's center wavelength by the zero detuning. For example, for a filter bank that has a passband of 20 GHz defined at a 0.05 dB ripple and at least 20 dB adjacent channel rejection, the multiplexer based on pole-zero filters can achieve a channel spacing of 45 GHz, or 45% bandwidth utilization. An all-pole 2^{nd}-order Butterworth filter, in contrast, achieves a channel spacing of 106 GHz, or bandwidth utilization under 19%. The pole-zero filter bank gives a 2.4 times denser channel packing (higher bandwidth density) with no increase in filter order.

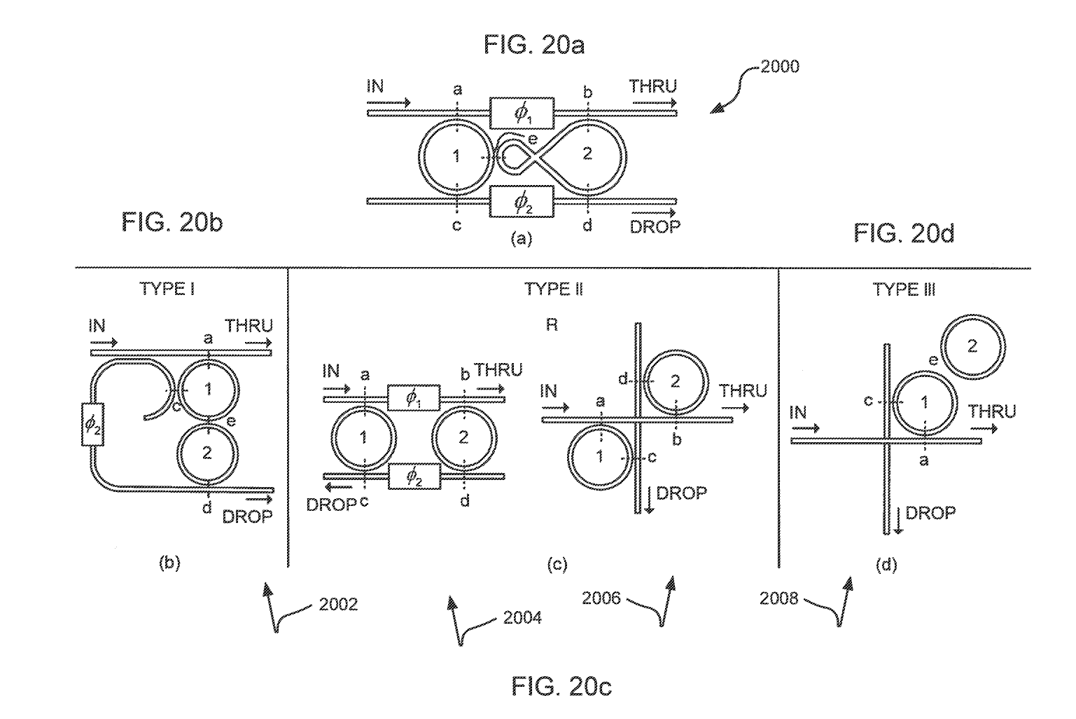

FIGS. 20a, 20b, 20c, and 20d illustrate example device topologies 2000, 2002, 2004, 2006, and 2008 that support a 2-pole, 1-zero response. The topology 2000 shows all of the degrees of freedom for a photonic circuit based on 2 traveling-wave resonators, that can produce a 2-pole, 1-zero response. Specifically, the topology 2000 calls for two waveguides (2 pairs of input and output ports), with each waveguide coupled to each resonator. The design provides access to 5 couplings and 2 phases. The topology 2002 has already been discussed at length herein. The topology 2004 has a robust through port rejection since the light is forced to pass through both of the rings, but the 2^{nd}-order portion of the drop port rolloff is sensitive due to the necessity of the proper phase relationship between rings 1 and 2. The topology 2006 uses the same coupling as the topology 2004, but employs unequal waveguide lengths and can provide a pole-zero filter response with different phase shifts. The topology 2008 employs 3 coupling points.

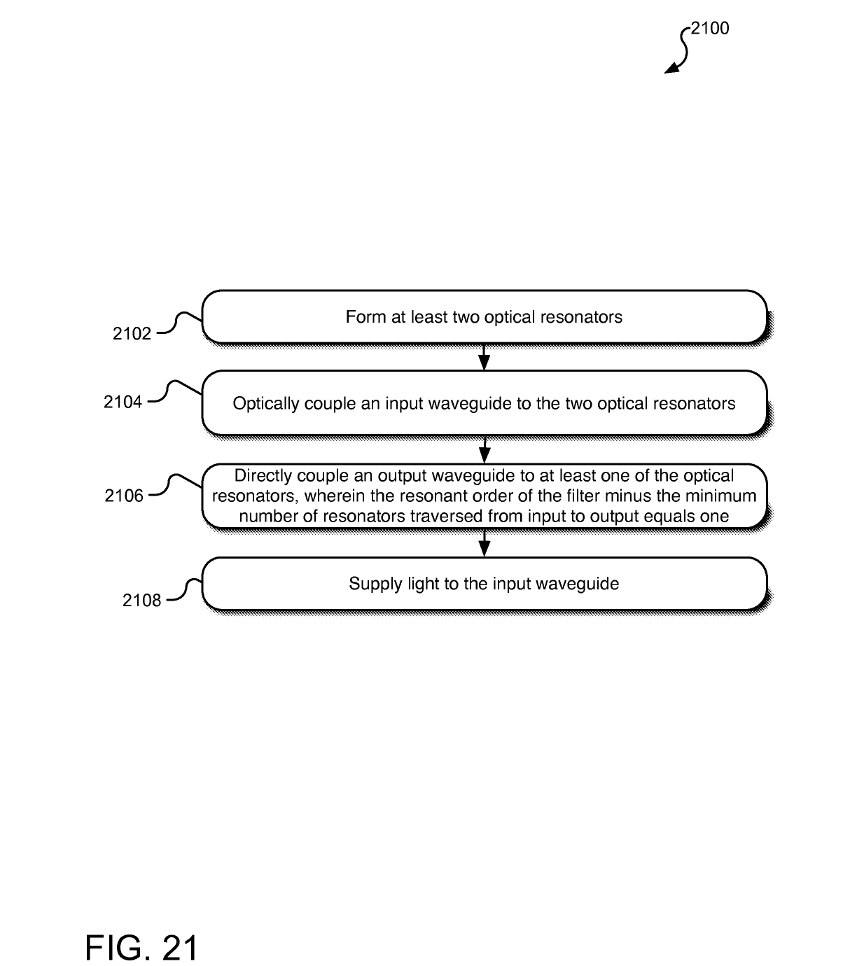

FIG. 21 illustrates example operations 2100 for making and using an optical pole-zero filter. A construction operation 2102 forms at least two optical resonators. A coupling operation 2104 optically couples an input waveguide to the two optical resonators. Another coupling operation 2106 directly couples an output waveguide to at least one of the optical resonators. In one implementation, to construct a 2-pole/1-zero optical filter, the resonant order of the filter minus the minimum number of resonators traversed from input to output equals one. Direct optical coupling refers to a coupling between two waveguides without any other waveguides between the two waveguides. In contrast, optical coupling, if not direct, may traverse multiple waveguides from input to output. A supply operation 2108 supplies light to the input waveguide.

It should also be understood that multiple optical pole-zero filters may be coupled in series to form an optical demultiplexer. In one implementation, each pole-zero filter stage includes two poles and one transmission zero outside the passband associated with the two poles. In addition, in some implementations, the transmission zero of a filter stage is located in the passband of the following filter stage of the multiplier.

The above specification, examples, and data provide a complete description of the structure and use of exemplary embodiments of the invention. Since many implementations of the invention can be made without departing from the spirit and scope of the invention, the invention resides in the claims hereinafter appended. Furthermore, structural features of the different embodiments may be combined in yet another implementation without departing from the recited claims. It should be understood that logical operations may be performed in any order, adding and omitting as desired, unless explicitly claimed otherwise or a specific order is inherently necessitated by the claim language.

### APPENDIX A

For a plane wave propagating in a bulk medium, the FWM coefficient, β_{fwm}, is directly related to the third-order susceptibility of the nonlinear material, χ̅⁽³⁾. In a microphotonic structure, the optical fields are tightly confined and the FWM coefficient also depends on an overlap integral of the interacting mode fields, given by

$${β}_{fwm , s} = \frac{\frac{3}{16} {ɛ}_{0} \int {d}^{3} \times ( {E}_{s}^{*} \cdot {{χ}^{=}}^{( 3 )} \text{:} {E}_{p}^{2} {E}_{i}^{*} )}{\sqrt{\int {d}^{3} \times ( \frac{1}{2} ɛ \vert {E}_{s}^{2} \vert ) \int {d}^{3} \times ( \frac{1}{2} ɛ {\vert {E}_{i} \vert}^{2} ) \int {d}^{3} \times ( \frac{1}{2} ɛ {\vert {E}_{p} \vert}^{2} )}} = \frac{3 {χ}_{1111}^{( 3 )}}{4 {n}_{nl}^{4} {ɛ}_{0} {V}_{eff}} \qquad ( A 1 )$$

where nₙₗ is the refractive index of nonlinear material, ε₀ is vacuum permittivity, V_{eff} is effective volume given by

V_{eff}≡χ₁₁₁₁⁽³⁾∫d₃x(ε|Eₛ|²)∫d³x(ε|Eᵢ|²)∫d³x(ε|Eₚ|²)/ε₀²nₙᵢ⁴∫d³x(Eₛ⁺· χ̅⁽³⁾:Eₚ²Eᵢ⁺. (A2)

The effective volume, V_{eff}, is the equivalent bulk volume of nonlinear medium, in which uniform fields with the same energy would have equal nonlinearity (β_{fwm}) With the full permutation symmetry of χ̅⁽³⁾, β_{fwm,x}=β_{fwm,i}=β*_{fwm,p} (the Manley-Row relations).

The nonlinear loss coefficients due to two-photon absorptions, β_{tpa,mn} (due to absorption of a photon each from modes m and n, m,nε{s,p,i}), are described by a similar overlap integral. For example,

$${β}_{tpa , sp} = \frac{\frac{3}{16} {ɛ}_{0} \int {d}^{3} \times ( {E}_{s}^{*} \cdot \vert {{χ}^{=}}^{( 3 )} \vert \text{:} {E}_{s} {E}_{p} {E}_{p}^{*} )}{\int {d}^{3} \times ( \frac{1}{2} ɛ \vert {E}_{s}^{2} \vert ) \int {d}^{3} \times ( \frac{1}{2} ɛ {\vert {E}_{p} \vert}^{2} )} . \qquad ( A3 )$$

### APPENDIX B

The loss rate of cavity mode amplitude envelope (Aₖ in the CMT model, for kε{s,p,i}) due to free carrier absorption induced by two-photon absorption (see Equation (4)). On the one hand, free carries are created through TPA with equal densities. In general, the dynamics of free carrier density, Nᵥ, is governed by the continuity equation

$$\frac{\partial {N}_{v}}{\partial t} = G - \frac{{N}_{v}}{{τ}_{v}} + {D}_{v} {∇}^{2} {N}_{v } - {s}_{v} {μ}_{v} ∇ \cdot ( {N}_{v} {E}_{dc} ) ≡ G - \frac{{N}_{v}}{{τ}_{v , eff}} \qquad ( B 1 )$$

where v=e for electrons, v=h for holes, sₕ=1, sₑ=−1, Dᵥ is the diffusion coefficient, μᵥ is the mobility, E_{dc} is the applied dc electric field, and τ_{v,eff} is the effective carrier lifetime that includes all the effects of recombination, diffusion and drift. G is the free carrier generation rate per volume due to TPA, where one pair of electron and hole is generated for every two photons absorbed

$$G = \frac{1}{2 ℏω} \frac{Δ E}{Δ t \cdot Δ V} = \frac{1}{4 ℏ ω} [ {E}_{tot}^{*} \cdot J ] = \frac{1}{4 ℏω} [ jω {ɛ}_{0} {E}_{tot}^{*} \cdot {{χ}^{=}}^{( 3 )} \text{:} {E}_{tot}^{3} ] \qquad ( B2 )$$

where Eₜₒₜ is the total electric field (Eₜₒₜ=Eₛ+Eₚ Eᵢ). Thus, the steady-state free carrier density is given by

Nᵥ=Gσ_{v,eff} (B3)

On the other hand, these free carriers contribute to optical loss. The free carrier absorption coefficient of optical power (absorption rate per distance) is

αᵥ=σᵥNᵥ (B4)

where σᵥ is the free carrier absorption cross section area. Note that both τ_{v,eff} and G are position-dependent, and therefore, the free-carrier absorption coefficient αᵥ is non-uniform across the waveguide cross-section. The optical field intensity is also non-uniform. As a result, the interplay between free carriers and the optical field are relevant. If the field decay rate due to free carrier loss is much smaller than the cavity resonance frequency, the FCA loss can be included into the perturbation theory of the CMT model, with the free carrier loss rate of mode k (for kε{s,p,i}) due to free carrier v as

$$\begin{matrix}{r}_{k , FC}^{v} = - \frac{jω}{4} \frac{\int {d}^{3} \times ( {E}_{k}^{*} \cdot δ {P}_{k}^{( FCA , v )} )}{\int {d}^{3} \times ( \frac{1}{2} ɛ {\vert {E}_{k} \vert}^{2} )} \\ = \frac{ω}{4} \frac{\int {d}^{3} \times ( {ɛ}_{0} {n}_{nl} \frac{{α}_{v}}{{k}_{0}} {\vert {E}_{k} \vert}^{2} )}{\int {d}^{3} \times ( \frac{1}{2} ɛ {\vert {E}_{k} \vert}^{2} )} \\ = \frac{{ɛ}_{0} {n}_{nl} ω {σ}_{v}}{4 {k}_{0}} \frac{\int {d}^{3} \times ( G {τ}_{v , eff} {\vert {E}_{k} \vert}^{2} )}{\int {d}^{3} \times ( \frac{1}{2} ɛ {\vert {E}_{k} \vert}^{2} )} \\ = \frac{c {ɛ}_{0}^{2} {n}_{nl} {σ}_{v}}{16 ℏ} \frac{\int {d}^{3} \times ( {τ}_{v , eff} ( {E}_{tot}^{*} \cdot [ {{χ}^{=}}^{( 3 )} ] \text{:} {E}_{tot}^{3} ) {\vert {E}_{k} \vert}^{2} )}{\int {d}^{3} \times ( \frac{1}{2} ɛ {\vert {E}_{k} \vert}^{2} )}\end{matrix} \qquad ( B5 )$$

The expression in Equation (B5) for free absorption rate can be simplified with some assumptions. First, the effective free carrier lifetime, τ_{v,eff}, is assumed to be the same for electrons and holes. Second, the steady-state free carrier density generated by the TPA is assumed to be uniform (invariant with respect to position) in the cavity, which is a valid assumption when the carrier density equilibrates due to a diffusion that is much faster than recombination, or a fast drift due to an applied field for carrier sweep out. With these assumptions, the effective volume of nonlinear interaction, V_{eff}, (defined in Appendix A), to average out the free carrier density, Nᵥ. From Equations (1a)-(1c), using

$$\frac{\partial {N}_{v}}{\partial t} = - \frac{{N}_{v}}{{τ}_{eff}} + \frac{1}{2 ℏω {V}_{eff}} \frac{d {\vert {A}_{k} \vert}^{2}}{d t} = 0 , \\ {N}_{v} = \frac{{τ}_{eff}}{ℏ {V}_{eff}} ( \begin{matrix}{β}_{tpa , ss} {\vert {A}_{s} \vert}^{4} + {β}_{tpa , pp} {\vert {A}_{p} \vert}^{4} + {β}_{tpa , ii} {\vert {A}_{i} \vert}^{4} + 4 {β}_{tpa , sp} {\vert {A}_{s} \vert}^{2} {\vert {A}_{p} \vert}^{2} + \\ 4 {β}_{tpa , ip} {\vert {A}_{i} \vert}^{2} {\vert {A}_{p} \vert}^{2} + 4 {β}_{tpa , si} {\vert {A}_{s} \vert}^{2} {\vert {A}_{i} \vert}^{2}\end{matrix} ) . \qquad ( B6 )$$

The optical field decay rate due to FCA is given by

$$\begin{matrix}{r}_{FC} = \frac{{α}_{FC} {υ}_{g}}{2} \\ = \frac{{σ}_{a} {N}_{v} {υ}_{g}}{2} \\ = \frac{{τ}_{eff} {σ}_{a} {υ}_{g}}{2 ℏ {V}_{eff}} ( \begin{matrix}{β}_{tpa , ss} {\vert {A}_{s} \vert}^{4} + {β}_{tpa , pp} {\vert {A}_{p} \vert}^{4} + {β}_{tpa , ii} {\vert {A}_{i} \vert}^{4} + \\ 4 {β}_{tpa , sp} {\vert {A}_{s} \vert}^{2} {\vert {A}_{p} \vert}^{2} + 4 {β}_{tpa , ip} {\vert {A}_{i} \vert}^{2} {\vert {A}_{p} \vert}^{2} + \\ 4 {β}_{tpa , si} {\vert {A}_{s} \vert}^{2} {\vert {A}_{i} \vert}^{2}\end{matrix} )\end{matrix} \qquad ( B7 )$$

where σₐ is the free carrier absorption cross section area, including contributions from both free electrons and holes, ν_{g} is the group velocity of optical modes.

What is claimed is:

1. A resonant photonic device comprising:
an optical resonator supporting a first resonance mode having a first resonant frequency, a second resonant mode having a second resonant frequency, and a third resonant mode having a third resonant frequency, the optical resonator having third-order optical nonlinearity; and
an optical waveguide input port and an optical waveguide output port, each coupled to each of the three resonant modes, the optical waveguide input port being more strongly coupled to the first resonant mode than to the second and third resonant modes, the optical waveguide output port being more strongly coupled to at least one of the second and third resonant modes than to the first resonant mode.

2. The resonant photonic device of claim 1 wherein the third-order optical nonlinearity causes a loss in the first resonant mode.

3. The resonant photonic device of claim 2 wherein the third-order optical nonlinearity causes a gain in the second and third resonant modes.

4. The resonant photonic device of claim 1 wherein the first resonant frequency, the second resonant frequency, and the third resonant frequency are all within one free spectral range.

5. The resonant photonic device of claim 1 wherein the first resonant mode is tuned on resonance with a pump wavelength, the second resonant mode is tuned on resonance with a signal wavelength, and the third resonant mode is tuned on resonance with an idler wavelength.

6. The resonant photonic device of claim 1 wherein electrical field distributions of the first, second, and third resonant modes have substantial spatial overlap.

7. The resonant photonic device of claim 1 wherein the optical resonator is formed of three coupled resonant cavities.

8. The resonant photonic device of claim 7 wherein the three coupled resonant cavities includes a first resonant cavity, a second resonant cavity, and a third resonant cavity, wherein the first resonant cavity is directly optically coupled to the second resonant cavity and the second resonant cavity is directly optically coupled to the third resonant cavity

9. The resonant photonic device of claim 8 wherein the optical waveguide output port is directly optically coupled to the second resonant cavity.

10. The resonant photonic device of claim 9 wherein the optical waveguide input port is directly optically coupled to at least one of the first or third resonant cavity.

11. The resonant photonic device of claim 7 wherein each resonant cavity includes a microring resonator.

12. The resonant photonic device of claim 7 wherein each resonant cavity includes a photonic crystal resonator cavity.

13. The resonant photonic device of claim 7 wherein each resonant cavity is in the shape of a circle, an oval, or a solid disk.

14. The resonant photonic device of claim 1 wherein the optical resonator is formed of a material selected from the group of silicon, a III-V semiconductor, silicon nitride, aluminum nitride, a glass, diamond, or a polymer.

15. The resonant photonic device of claim 1 wherein the optical resonator includes a standing wave resonator.

16. The resonant photonic device of claim 1 wherein the optical resonator includes a traveling wave resonator.

17. A method comprising:
forming an optical resonator supporting a first resonance mode having a first resonant frequency, a second resonant mode having a second resonant frequency, and a third resonant mode having a third resonant frequency, the optical resonator having third-order optical nonlinearity; and
optically coupling each of an optical waveguide input port and an optical waveguide output port to each of the three resonant modes, the optical input port being more strongly coupled to the first resonant mode than to the second and third resonant modes, the optical output port being more strongly coupled to at least one of the second and third resonant modes than to the first resonant mode.

18. The method of claim 17 wherein the third-order optical nonlinearity causes a gain in the second and third resonant modes and a loss in the first resonant mode.

19. The method of claim 17 wherein the first resonant frequency, the second resonant frequency, and the third resonant frequency are all within one free spectral range.

20. The method of claim 17 wherein the first resonant mode is tuned on resonance with a pump wavelength, the second resonant mode is tuned on resonance with a signal wavelength, and the third resonant mode is tuned on resonance with an idler wavelength.

21. The method of claim 17 wherein the optical resonator is formed of three coupled resonant cavities.

22. An optical filter comprising:
a first optical resonator;
a second optical resonator;
an input waveguide optically coupled to the first and second optical resonators; and
an output waveguide directly optically coupled to the first optical resonator, wherein the optical filter is configured to provide a passband having at least two poles and a transmission zero positioned outside a frequency range between the two poles.

23. The optical filter of claim 22 wherein the input waveguide is configured to carry an input signal having a channel spacing, the zero being shifted substantially by a channel spacing from the center of the passband.

24. The optical filter of claim 22 wherein the input waveguide is directly optically coupled to the second optical resonator and the output waveguide is directly optically coupled the second optical resonator, the coupling between the output waveguide and the second optical resonator being weaker than the coupling between the output waveguide and the first optical resonator.

25. The optical filter of claim 22 further comprising:
a third optical resonator optically coupled to the first optical resonator and the second optical resonator, wherein the input waveguide is directly optically coupled to the third optical resonator and the output waveguide is directly optically coupled the second optical resonator, the coupling between the output waveguide and the second optical resonator being weaker than the coupling between the output waveguide and the first optical resonator.

26. The optical filter of claim 22 further comprising:
a third optical resonator optically coupled to the first optical resonator and the second optical resonator;
a fourth optical resonator optically coupled to the first optical resonator, the second optical resonator, and the third optical resonator, wherein the input waveguide is directly optically coupled to the fourth optical resonator and the output waveguide is directly optically coupled the second optical resonator, the coupling between the output waveguide and the second optical resonator being weaker than the coupling between the output waveguide and the first optical resonator.

27. A method comprising:
optically coupling an input waveguide to a first optical resonator and second optical resonator;
directly optically coupling an output waveguide to the first optical resonator, wherein the optical filter is configured to provide a passband having at least two poles and a transmission zero positioned outside a frequency range between the two poles.

28. The method of claim 27 wherein the input waveguide is configured to carry an input signal having a channel spacing, the zero being shifted substantially by a channel spacing from the center of the passband.

29. The method of claim 27 wherein the input waveguide is directly optically coupled to the second optical resonator and the output waveguide is directly optically coupled the second optical resonator, the coupling between the output waveguide and the second optical resonator being weaker than the coupling between the output waveguide and the first optical resonator.

30. An optical demultiplexer comprising:
a first optical filter configured to provide a first passband having at least two first poles and a first zero positioned outside a first frequency range between the two first poles, the first zero being shifted from a center of the first passband by a channel spacing; and
a second optical filter coupled in series with the first optical filter, the second optical filter being configured to provide a second passband having at least two second poles and a second zero positioned outside a second frequency range between the two second poles, wherein the first zero is located within the second passband.

31. A method comprising:
forming a first optical filter configured to provide a first passband having at least two first poles and a first zero positioned outside a first frequency range between the two first poles, the first zero being shifted from a center of the first passband by a channel spacing;
forming a second optical filter, the second optical filter being configured to provide at least two second poles and a second zero positioned outside a second frequency range between the two second poles; and
coupled the first and second optical filters in series, wherein the first zero is located within the second passband.
